(19) United States
(12) Patent Application Publication
(10) Pub. No.: US 2015/0000190 A1
(43) Pub. Date: Jan. 1, 2015

(54) Automated Plant Growing System

(71) Applicant: AliGroWorks USA, Inc., Palm Desert, CA (US)

(72) Inventor: Adam Gibbons, Calimesa, CA (US)

(21) Appl. No.: 14/300,116

(22) Filed: Jun. 9, 2014

Related U.S. Application Data
(60) Provisional application No. 61/859,127, filed on Jul. 26, 2013.
(60) Provisional application No. 61/832,311, filed on Jun. 7, 2013.

(51) Int. Cl. A01G 27/00

(52) U.S. Cl. CPC A01G 27/005
USPC 47/66.6; 47/79

(57) ABSTRACT

A controlled environment agricultural system having a self-regulating grow module that automatically waters the plant without over-watering or under-watering. The system may further comprise a self-regulating lift mechanism with an optic sensor, the lift mechanism capable of raising, lowering, and rotating each grow module independently of any other grow module, to monitor and provide individual attention to individual plants within a crop in order to maximize growth and plant yield.

### CROSS-REFERENCE TO RELATED APPLICATION

This application claims the benefit of U.S. Provisional Patent Application Ser. No. 61/832,311, filed Jun. 7, 2013, and U.S. Provisional Patent Application Ser. No. 61/859,127, filed Jul. 26, 2013, which applications are incorporated in their entirety here by this reference.

### TECHNICAL FIELD

This invention relates to a controlled environment agricultural system that implements a self-regulating system to maintain optimum conditions to individual plants within a crop in order to maximize plant growth and yield.

### BACKGROUND

The goal of any controlled environment agriculture facility or grow room is to produce a consistent crop in both quality and quantity day-after-day, regardless of season, at an affordable cost. The key factor in achieving this goal is the plant's distance and orientation to the light. No other influence has a greater effect on a plant's ability to produce phenomenal yields than how that plant is positioned under the light source.

It is a common occurrence to see lighting apparatuses mounted on the ceiling and grow modules located on the floor. This substantial distance between plant and light source has devastating consequences on the crop owner/investor's pocketbook in a number of ways that will become evident as described below.

Aside from light, proper watering is another critical factor affecting a plant's ability to flourish. Most people simply hand water their plants or use timers. Hand watering is time consuming and can lead to over-watering or under-watering. Timers can have the same effect. Since the weather is constantly changing watering a plant for the same period of time every day does not necessarily provide the right amount of water each day. Some may simply over-water their plants to make sure it is not under-watered. Over watering involves drainage holes to allow excess water to flow out. This, however, is a waste of water.

To never over water, never under water, and never hand water one's plants is a fantasy come true for a majority of gardeners or growers, and surely is Mother Nature's wet dream. Consistently providing the exact amount of water required by a plant to thrive is a challenge even for those with the greenest of thumbs. Temperature, humidity, root zone conditions, plant size and species, as well as dozens of other factors play a part in determining how much water a plant needs to flourish on any given day. Missing the mark can mean irreversible damage to the plant, possibly leading to death, or it can hinder a crops ability to generate optimal yields. And missing the mark always means wasting precious water, which is unfavorable to the plant, to the planet, and to the grower/Investor's pocketbook.

Over watering, under watering and irregularly watering harms the plant and wastes water in a world where water is a rapidly disappearing element. Over watering is a waste for obvious reasons: unneeded water runs off, is evaporated, and/or causes the plant to expend energy driving excess water away to prevent drowning. Under watering is a waste because the plant is using the scarce amount of water provided to recover from or adapt to less-than-ideal water conditions. Irregularly watering causes the plant to be constantly in a defensive position—fighting to stay alive—instead of being on the offense generating phenomenal yields. In the water starved world in which we all live, every single ounce of water needs to be used to efficiently grow a plant's bounty.

The daily task of watering one's plants is tedious and is often ignored. Work, children, vacation, illness, lack of free time and laziness are only a few on a laundry list of reasons why plants do not get watered consistently. And to compound the problem of not watering on a regular schedule, novice growers mistakenly believe that over watering the plant today will make up for days missed or for days anticipated to be away. Grave consequences are a sure outcome of this aquatic blunder.

Highly effective water conservation products and efforts are of immediate urgency the globe over. The present invention plays a critical role in such an effort by minimizing plant's dependence on humans in the watering process—whether in a gardener's backyard or a grower's commercial operation. Removing but an participation means removing shameful water waste.

For the reasons stated above and others not noted, there is a need for a plant growth module/planter that ensures the grower never over waters, never under waters, and never hand waters their plants . . . EVER.

Therefore, there is a need for a system that can maintain the proper distance of a plant from its light source to maximize the growing potential of the plant, while providing a watering system that is automated so as not to over-water, under-water, or manually water any plant

### SUMMARY

The present invention is directed to a plant growing system that creates the most optimal conditions for plant growth. The term plant includes trees, flowers, vines, and a other organism under the kingdom Plantae. In the preferred embodiment, the system comprises a grow module that automatically waters the plant without over-watering, under-watering, or manually watering the plant. The grow module can be configured with sensors to optimize other conditions for optimal plant growth.

The grow module can be used in conjunction with a lift system that places the plant at an ideal location from a light source. The lift system utilizes a rotating lift mechanism and a controller with an optic sensor. The system is designed and engineered to provide individual attention to each individual plant within a crop. Although plants are often times clones, without equal attention given to each plant there will be considerable differences in size and yield. In cases when the crop/investment has medicinal properties, there can be potency inconsistencies as well. The system virtually alleviates these variances by either focusing grow room variable solutions to individual plant sites or by controlling, monitoring, and/or avoiding grow room variables at each individual plant site.

The system of the present application sets out to provide fortunate owners who often times have no prior growing experience, have been misled, or use outdated techniques a sense of comfort knowing their investment (crop) is in safe hands with the most advanced combination of grow techniques and grow technologies in a single automated unit. Furthermore, the owners will experience relief knowing that their wallet and conscience are not being maliciously attacked by an inefficient piece of equipment that wastes energy (which has both financial and environmental consequence) and that they can rely on a product of consistent quality and quantity with minimal effort.

The need for such advanced automated systems is vast with a broad spectrum of target users. Customers will range from the general garden enthusiast, organic foods consumer, and herbal medicine grower to plant physiology researchers, biotechnology and pharmacology industries, fertilizer developers as well as Controlled Environment Agriculture facilities (CEA), schools and universities. Customers will also include remote (and often times offshore) oil and diamond exploration companies, hotel and restaurant chains located afar that wish to include fresh/organic menu options year round from exotic venues; world hunger, global medical service providers, and international charities heading abroad where food supply is sparse or unpalatable. Finally, military and government efforts that may require food supply without a compromise in security (e.g. covert observation and intelligence gathering mission within hostile territory where entry to the said location could jeopardize valued personnel).

The system has very significant water/nutrient delivery advancements that makes it unlike any other product. All of the other multi-plant grow systems on the market have a community pool of water from which all plants must share. They are made up of a single water source and/or a single reservoir that a combination of water and nutrients are drawn and then introduced to the crop's roots, including systems that utilize recirculation technologies. This means that every plant within that crop must be of the same species (or favor the same nutrient solution) and must be in the same lifecycle stage—all must be in the vegetative stage or all must be in the flowering stage—because the nutrient needs are different during each stage of life.

The present system provides each plant site/grow module with its own source of water and nutrient solution. No two plants need to share the same source of food and drink. Additionally, no two plants need to be grown via the same technique; meaning one plant may be grown by traditional soil means while another may be simultaneously grown by a newer “progressive gardening” technique such as hydroponics or aeroponics. This is significant because this allows individualized attention to an individual plant's needs using whichever grow medium (soil, water, or air) is required by application or preferred by the grower. Thus, allowing for important research to take place, allowing crops of various strains and maturity to accompany one another, etc. Equally important, it prevents the spread of root borne diseases and other water/nutrient problems that may regrettably occur. In regards to water/nutrient supply, by design, the system is an “insurance policy” that guarantees the entire investment is not lost, in one sad swoop of aquatic misfortune.

The system utilizes a revolutionary planter design that is relished with relevant features and capabilities not found in prior art. In the preferred embodiment, the planters/grow modules come in a plurality of configurations—soil and soil-less—that share the same outer housing yet each configuration has its own unique inner components.

The planter/grow module is divided into two key areas: 1) Root. Zone and 2) Reservoir Area, The Root Zone of the planter is the location in which the plant's roots are grown. The Reservoir Area of the planter is the location where the water/nutrient supply is delivered to and stored for use.

Roots tell us a lot about the plant's health, and ultimately, how well our crop and/or yields may be. For this reason, the present invention may have “root windows,” These root windows allow the grower to examine the Root Zone with ease and are of particular importance in the Aeroponic/Hydroponic Hybrid Planter embodiment where roots are suspended in air.

A built-in collapsible trellis feature, such as a tomato cage, provides plant support on-call. When growing tall plants that require support such as tomatoes, peppers, or some varieties of herbs, simply extend the tomato cage. If growing lettuce, carrots, or flowers, collapse the tomato cage into the planter.

To help minimize evaporation, weed growth, and pest infestation grow medium covers may be included. This simple yet effective feature conserves water and minimizes the need for pesticides and weed preventers.

Easily accessing to the Reservoir Area of the planter without having to remove the plant is not only convenient, it is important. Plants experience “stress”, which could very well lead to death, when being removed from their planters or the ground. Being able to access the system components for repair or replacement, cleaning the Reservoir Area, manually testing water/nutrient levels, etc. and not having to uproot the plant is a lifesaver.

As stated above, human participation in the watering process is devastating to plant life, to water conservation efforts, and to wallets. The present invention not, only eliminates the need to water one's plants—it perfectly waters plants unfailingly with zero water waste. To achieve this amazing claim, the system utilizes three key components: 1) fluid fill level control device (aka “float valve”), 2) wicking instrument (aka “wicking basket”), and 3) aerator.

A water/nutrient solution supply line comes in communication with the fluid fill level control device, which in turn keeps the reservoir filled to a desirable level. Thus, the planter is always supplied with an ideal amount of water/nutrients without hand watering. A wicking instrument, then facilitates capillary action, allowing the plant to draw water from the reservoir or to drive access water to the reservoir, therefore, never over watering or under watering. (Note: Excess water, for example, could be introduced to the Root Zone of the planter on rainy days.)

It is critical to understand that air equals yield. The more air we can introduce to the Root Zone, the greater the harvest. Increasing Root Zone oxygenation is paramount to increasing crop yields, and therefore, an aerator is an important feature of the present invention. The air stone serves a dual purpose. For one it aerates the water in the Reservoir Area, preventing the negative consequences of stagnant, nutrient-rich water (a breeding ground for bacteria and such.) Secondly, oxygen-rich water is drawn to the roots by the plant, providing the yield maximizing conditions/environment only afforded by an oxygenated Root Zone.

The system further optimizes growing conditions by providing a divider that separates the root zone from the reservoir area. The divider may have hundreds of tiny drain/aeration holes rather than by having fewer large holes. Roots that reach into the Reservoir Area and/or soak in the water/nutrient solution are prone to root rot and other root-related ailments. Having a greater number of little holes helps prevent roots from accessing the Reservoir Area from the Root Zone and allows for good air flow to the Root Zone from the Reservoir Area.

In some embodiments, the present invention of the present application utilizes highly advanced planters/grow modules equipped with both aeroponic and hydroponic functionality in a single unit—an aeroponic primary operating system and a hydroponic failsafe backup system. It is to be understood, however, that the same or equivalent functions may be accomplished by different embodiments that are also intended to be encompassed within the spirit and scope of the invention. For example, a planter/grow module may be constructed that has only aeroponic capabilities or only hydroponic capabilities.

In relation to aeroponics, prior art falls into one of two groups of systems. The first group consists of aeroponic systems designed for multiple plants within a single housing. The second group consists of systems advertised as “aeroponic;” which in actuality provide hydroponic nutrient delivery. Neither group provides individualized attention to individual plants within a multi-plant system nor do they provide the depth of system control required to maximize crop yields while using the absolute least amount of water.

Realizing yields beyond the capability of any other technique or technology requires many precise components working seamlessly together to manage every variable of the Root Zone. Water/nutrient, atomization, temperature and humidity levels, oxygenation versus dosing ratios, air introduction and circulation practices, and more contributes to the success of each plant.

Atomization occurs when the relative velocity between air and water is high enough to rip the water apart and into small particles—or droplets. In general, the higher this relative velocity the smaller the average droplet size will be. Unlike prior art, the present invention uses a centrifugal atomizer. Centrifugal atomization uses centrifugal force to accelerate the water/nutrient solution to a speed high enough for atomization. The system simply requires water/nutrient solution to come in communication with the center portion of the spinning disk for operation. It does not rely on high pressures or flow rates (as does prior art) and droplet size can be easily controlled by increasing or decreasing the speed at which the disk is spinning (studies by NASA and other reputable institutions have determined that different droplet size is favored during different stages of a plant's lifecycle.)

A primary system failure detection instrument (e.g. a water sensing circuit) will monitor the primary system, and in the event of failure, will activate the backup system. The backup system (e.g. a drip system) ensures nutrients reach the Root Zone during primary system downtime, as there is no soil acting as a nutrient reserve for the plant to tap.

Temperature monitoring is performed by having thermistors in various locations in the Root Zone. By having sensors in various locations, an average can be calculated and the temperature of the Root Zone can be accurately monitored and controlled.

Humidity monitoring is of high importance as it gives a quick look at the status of the root system—low humidity can alert the user that the roots may be drying out. Changes in relative humidity can be monitored, for example, by a capacitive type hygrometer.

To accomplish air flow to the Root Zone, a function that helps control temperature and contributes to oxygenation, a fan is incorporated in the design. As stated before, air equals yield, so oxygenation in the Root Zone is a key factor to producing elevated yields.

### BRIEF DESCRIPTION OF DRAWINGS

FIG. 1 shows an embodiment of the grow module in use with portions removed to see the inside.

FIG. 2 shows a perspective view of an embodiment of the grow module.

FIG. 3 shows the embodiment in FIG. 2 with the door and part of the lid removed.

FIG. 4 shows a perspective view of the bottom thereof.

FIG. 5 is a cross-sectional elevation view thereof.

FIG. 6 shows a perspective of the grow module with the trellis in the expanded configuration,

FIG. 7 shows a close-up perspective view of an embodiment of the reservoir pan.

FIG. 8 shows a side view of an embodiment of a float valve,

FIG. 9 shows a cross-section view thereof.

FIG. 10 shows a perspective view of another embodiment of the grow module with portions of the wall removed to see inside.

FIG. 11 shows an exploded view of the watering system of the grow module shown in FIG. 10,

FIGS. 12A and 12B show a bottom view and a top view, respectively, of an embodiment of the atomizer.

FIG. 12C shows a cross-sectional side view, taken through line K-K shown in

FIG. 12B, showing the flow of air and water.

FIG. 13 shows an embodiment of the flow generator.

FIG. 14 shows a perspective view of an embodiment of the diffuser.

FIG. 15A shows a top view of a grow module kit assembled.

FIG. 15B shows a top view of a grow module kit with the divider removed to show the contents below the divider.

FIG. 15C shows a side view of the grow module kit showing the measuring device used in creating the inlet.

FIG. 16A shows a top view of the float valve installed on a circular planter.

FIG. 16B shows the same top view with a wedge washer installed with the float valve,

FIGS. 16C and 16D show a front view and a side view, respectively, of an embodiment of the wedge washer.

FIG. 17 shows a perspective view of an embodiment of the lift system.

FIG. 18 shows close-up view of a base portion of the lift system thereof,

FIG. 19 shows a close-up side view of the base portion thereof.

FIG. 20 shows an exploded view of an embodiment of the lift plate.

FIG. 21 shows a close-up side view of the lifting mechanism.

FIG. 22 shows a bottom view of the lifting mechanism.

FIG. 23 shows a side view of an embodiment of the lift system in use (right side) as compared to typical grow rooms (left side).

FIG. 24 shows an embodiment of the controller.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The automated plant growing system of the present invention comprises a grow module 114 configured so as to practically eliminate over-watering, under-watering, and manual-watering of plants for optimal plant growth and minimized waste. In conjunction with a unique lift system 102, the plants not only get the proper water and nutrients, but also the optimal exposure to light.

The system will serve many markets, and therefore, can be purchased in various configurations. In one embodiment, the system will, be sold to individual consumers, primarily with the intent of personal use as an appliance-sized unit with an appliance-looking (i.e. stainless steel, slate, etc.) or cabinet-looking mahogany, oak, etc.) appearance. In another embodiment, the system will be sold to commercial and/or large scale growers with intent to mass produce. For example, in one embodiment, the system may be contained in an 8 ft×40 ft sized unit, referred to as a grow room. These units may be repurposed shipping containers that can be easily transported to global locations without any additional permits (i.e. wide load, excess weight, etc.). Each commercial grow room unit may have a plurality of plant growing systems. For example, some units may contain approximately 8-24 systems of the present invention.

Grow room components must work harmoniously together to provide and maintain conditions that promote accelerated plant growth. Dramatic fluctuations will slow or stop this enhanced growth process. Reversing the damage caused by the fluctuations is time-consuming and, therefore, costly. Controlling and monitoring grow room variables is paramount. These variables include, but are not limited to, the following: light intensity, “hot spots,” day/night times, carbon dioxide enrichment, air temperature, air circulation, humidity, water temperature, water aeration, water/nutrient delivery and re-circulation, nutrient levels, and grow calendars/plant lifecycles. The system is the principal solution to addressing these variables.

Monitoring grow room conditions, making the necessary adjustments, evenly distributing the results and then communicating these facts to the grower/investor is important. The investor does virtually nothing but watch via his smart phone, tablet, or computer.

Grow Module

The grow module 114 has very significant plumbing advancements that make it unlike any other product. All of the other multi-plant grow systems on the market have a community pool of water from which all plants must share. They are made up of a single water source and/or a single reservoir that a combination of water and nutrients are drawn and then introduced to the crop, including systems that utilize recirculation technologies. This means that every plant within that crop must be of the same species (or favor the same nutrient solution) and must be in the same lifecycle stage—all must be in the vegetative stage or all must be in the flowering stage—because the nutrient needs are different during each stage of life.

The present system provides each plant site/grow module its own source of water and nutrient solution. No two plants need to share the same source of food and drink. This is significant because this allows individual attention to an individual plant's needs and desires; thus, allowing for important research to take place, allowing crops of various strands and age to accompany one another, etc. Equally important, it prevents the spread of root borne diseases and other water/nutrient problems that may regrettably occur. In regards to water/nutrient supply, by design, the system is an “insurance policy” that guarantees the entire investment is not lost in one sad swoop of aquatic misfortune.

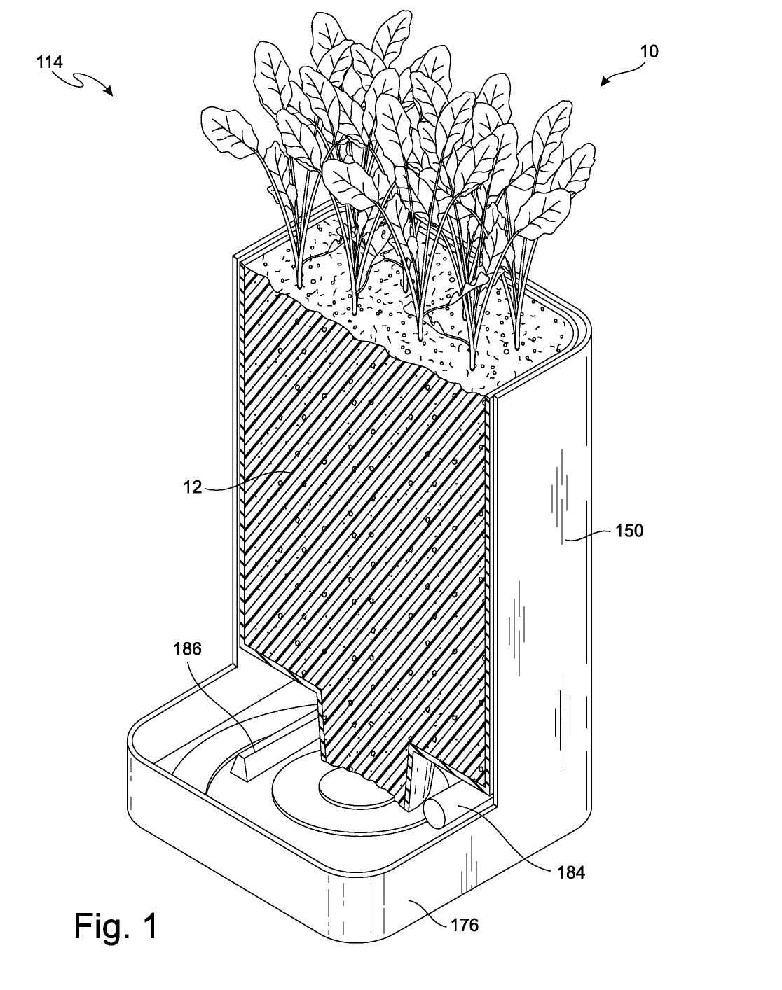

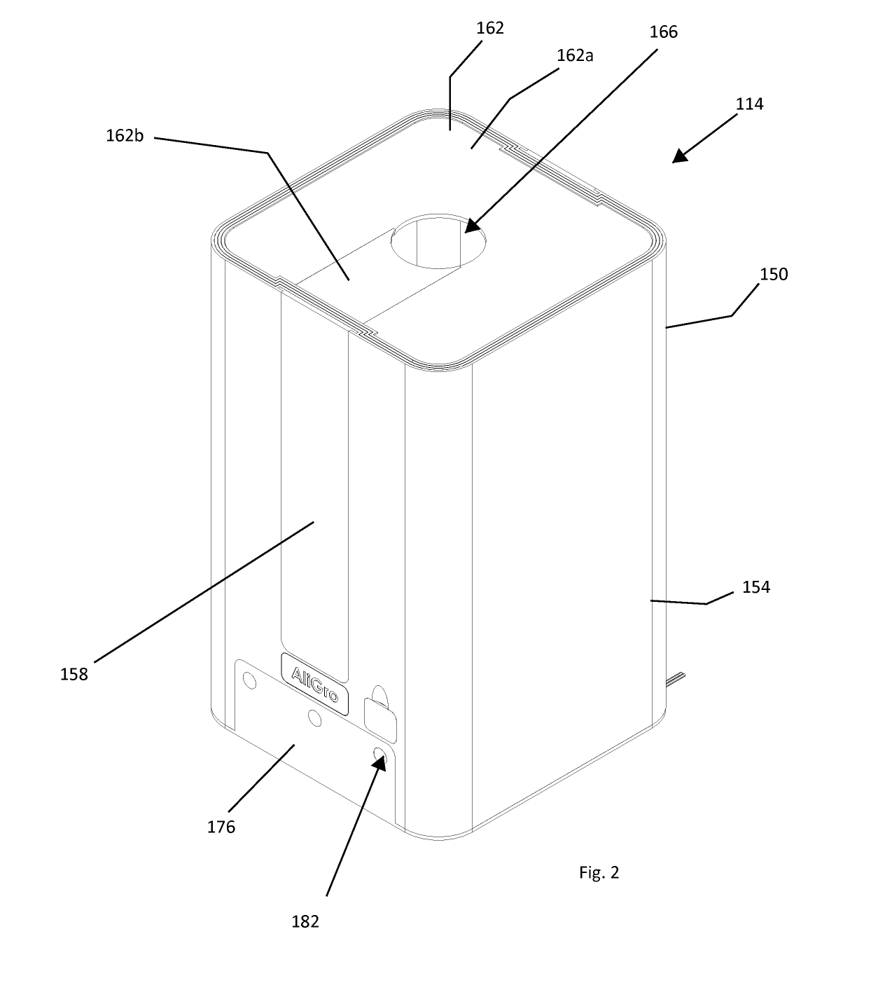

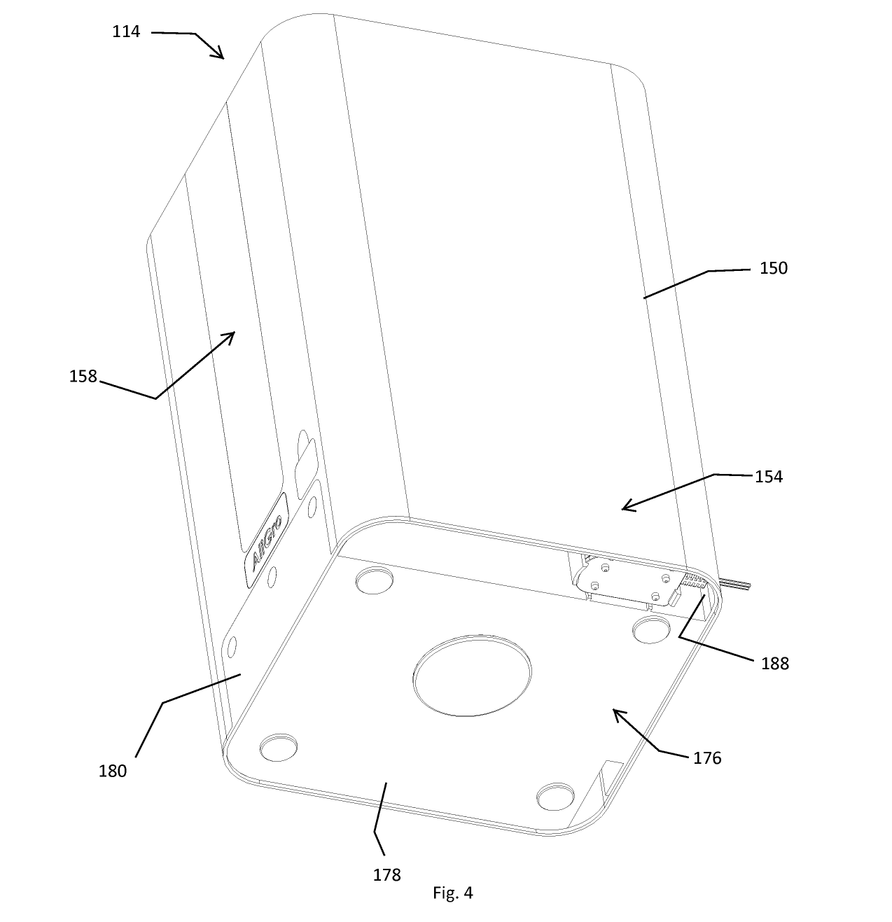

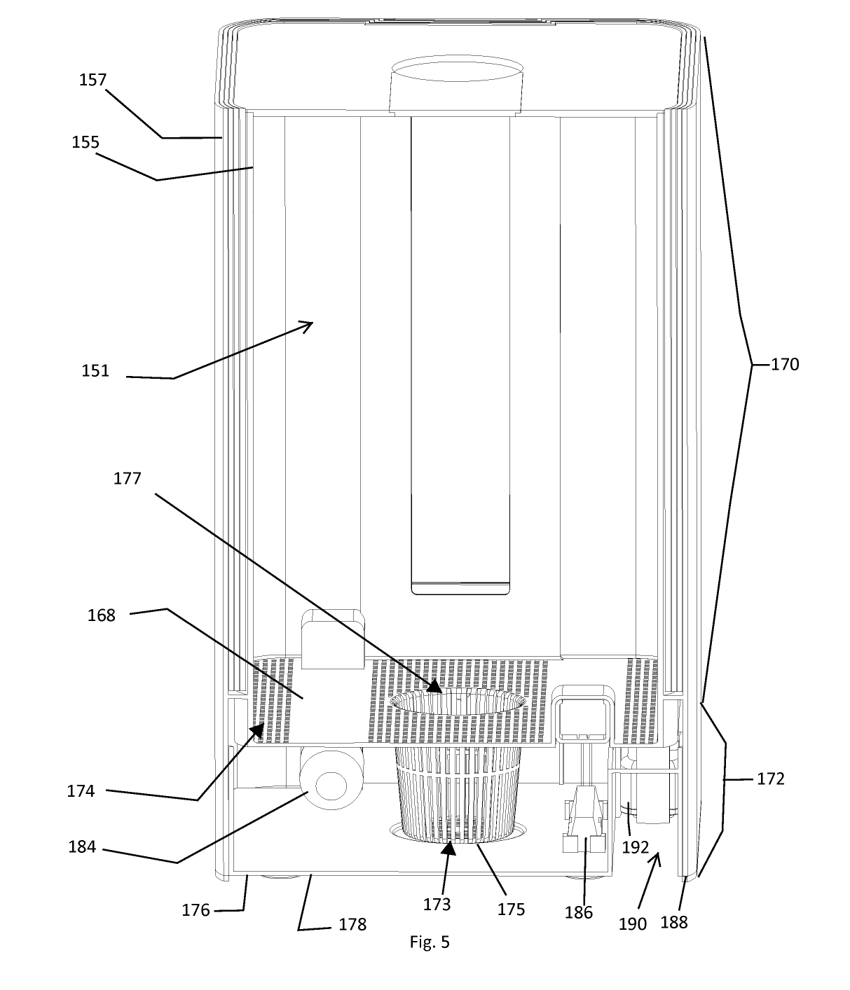

The grow module 114 is used to house an individual plant 10 in soil or potting mix 12, as shown in FIG. 1. With reference to FIGS. 2-5, in the preferred embodiment, the grow module 114 comprises a housing 150 and a reservoir pan 176. The housing 150 comprises a sidewall 154 defining a main cavity 151. The main cavity 151 may be divided into a root zone 170 and a reservoir area 172 below the root zone 170, as shown in FIG. 5. Depending on the shape of the grow module 114, the sidewall 154 may be comprised of multiple walls (e.g. front, back, and sides) attached together, or a single wall having multiple side portions (e.g. front, back, and sides), or a single wall with no particular orientation (e.g., cylindrical). Therefore, reference to a sidewall is not intended to limit the sidewall to a specific number. Therefore, the housing 150 may take on any shape, including, by way of example only, a cylinder, a triangle, a rectangle, and the like, as long as the plant is provided the ability to grow upwards as needed and its leaves have sufficient access to light.

At least a portion of the sidewall 154 may be a dual panel sidewall comprising an inner wall 155 and an outer wall 157 surrounding the inner wall 155, in which case the inner wall 155 defines the main cavity 151, as shown in FIG. 5. In some embodiments, at least a portion of the dual panel sidewall may have a transparent portion 156 so that the interior of the housing 150 can be seen. In other words, the housing 150 may have a window to see inside the housing 150. In some embodiments, only the inner wall 155 may have the transparent portion 156.

On the outer wall 157, adjacent to the transparent portion 156 of the inner wall 155 may be a door 158. This allows the user to open the door 158 of the outer wall 157 to expose the transparent portion 156 of the inner wall 155 in order to see inside the housing 150. In other embodiments, the grow module 114 may utilize an opaque housing 150 with a viewing window 156 in order to monitor plant roots and growth.

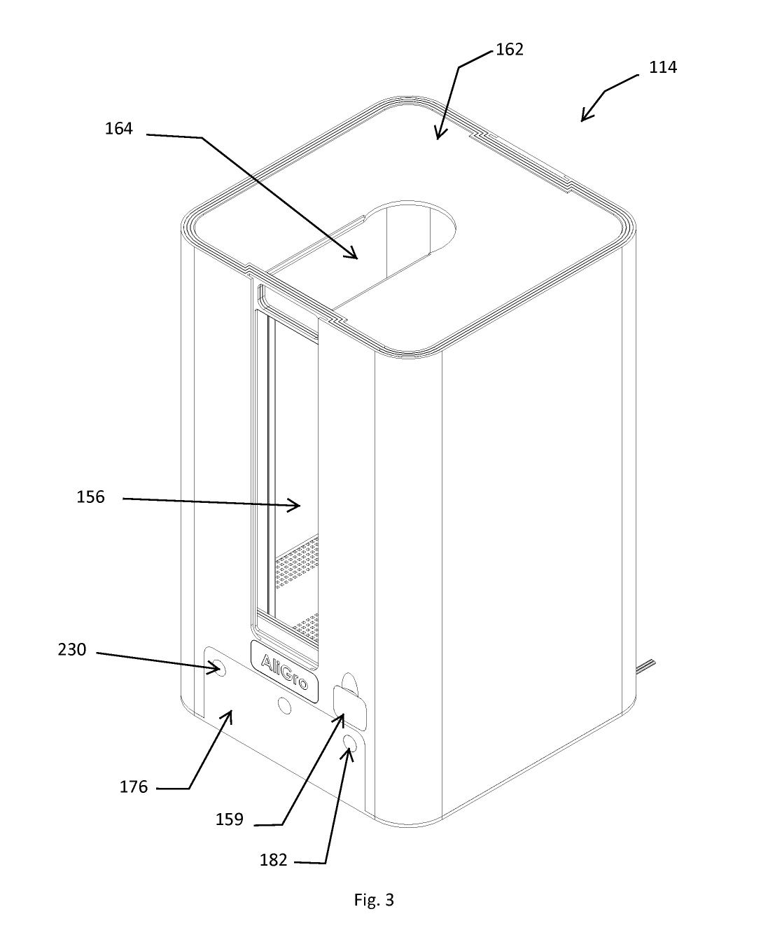

In some embodiments, the grow module 114 may further comprise a lid 162 to cover the main cavity 151, as shown in FIGS. 2 and 3. In the preferred embodiment, the lid 162 is a segmented lid 162 having a first lid piece 162a and a second lid piece 162b that fit together to form the fully assembled lid 162. The lid 162 may be segmented into even more pieces if preferred. The first lid piece 162a defines a slot 164 into which the second lid piece 162 can be inserted to fully assemble the segmented lid 162. When fully assembled, the segmented lid 162 defines a grow hole 166. By making the lid 162 in multiple pieces, the lid 162 can be placed on the housing 150 without disrupting the plant 10 that has already been planted in the grow module 114. Thus, the first lid piece 162a can be placed or slid onto the housing 150 with the plant 10 being inserted into the slot 164. The second lid piece 162b may be attachable to the first lid piece 162a using tongue and groove type attachment, or any other attachment to allow the second lid piece 162b to mate with the first lid piece 162a. The second lid piece 162b can then be slid or placed into the slot 164 towards the plant. The second lid piece 16M stops short of fully closing the slot 164 to define the grow hole 166. The grow hole 166 then allows the plant to continue growing out of the housing 150.

The segmented lid 162 can be made up of a plurality of slidable and removable pieces. With multiple sliding and removable lid pieces, the grow hole 166 can be made larger, smaller, different shapes, and put into different positions. For example, although shown centrally located, the grow hole 166 can be position offset from the center, if necessary. This reduces the need for the user to place the plant exactly in the center of housing 150.

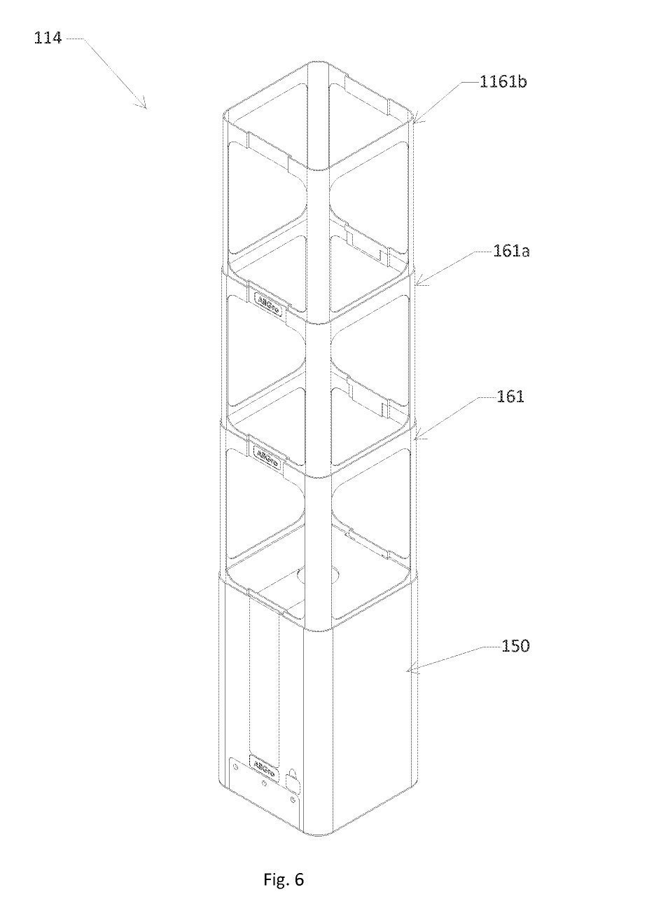

In some embodiments, the grow module 114 may also comprise a trellis 161, as shown in FIG. 6. The trellis can be attached to the housing 150. Preferably, the trellis 161 has a telescoping action so that it can be expanded to various heights. Preferably, the trellis 161 is housed in between the inner wall 155 and the outer wall 157 of the dual panel sidewall. Thus, in the collapsed configuration, the trellis 161 is hidden within the walls 155, 157 of the housing 150. When expanded, the trellis 161 extends above the lid 162. This allows plants with vines to grow up along the trellis 161. The trellis 161 can also be used as a protective barrier for plants in general. So, even for plants that may not need the trellis 161 for vines, the trellis 161 can still be expanded to protect the plants. This may be useful, for example, during transportation of the grow module 114 to different locations when a plant has already been planted. By way of example only, the telescoping trellis can be made by concentrically arranging substantially similar trellis pieces 161, 161.a, 161b like a telescope.

In some embodiments, the grow module 114 may comprise a chute 159. The chute 159 can be created through the lid 162, the sidewall 154, or through the reservoir pan 176. The chute 159 allows nutrients to be deposited into the grow module 114 from the outside. In the preferred embodiment, the chute 159 is formed in the sidewall 154. The sidewall 154 may comprise an opening to receive the chute 159. The chute 159 may be a door, a drawer, a channel, or some other passageway that leads from the outside of the grow module 114 to the inside of the grow module 114, and in particular, to the reservoir area 172. The user can open the chute 159, deposit the nutrient, and close the chute 159. The nutrient then falls into the reservoir area 172. In some embodiments, this may be automated by attaching a delivery device, such as tubing, to the chute 159. The delivery device may be attached to a nutrient reservoir and controlled by a controller 201 to release a certain amount id/or certain type of nutrient according to established instructions or protocol.

As shown in FIG. 5, in some embodiments, the grow module 114 may comprise a divider 168 separating the main cavity of the housing into the root zone 170 and the reservoir area 172. In the preferred embodiment, the divider 168 may comprise a wicking basket 175, a plurality of small holes 174, and a main opening 177 leading into the wicking basket 175. The divider 168 is a flat piece of rigid material that is strong enough to hold the soil 12 that will fill the root zone 170. The plurality of small holes 174 are small enough so that the soil does not continuously fall through and fill the reservoir area 172. In addition, the small holes 174 prevent the roots of the plant from entering the reservoir area 172. The divider 168 has a top surface and a bottom surface. The wicking basket 175 extends below the bottom surface; and therefore, into the reservoir area 172. The wicking basket 175 comprises a plurality of openings 173 allowing the reservoir area 172 and the root zone 170 to maintain fluid communications. The wicking basket 175 can be filled with dirt and/or soil. Like the small holes 174, the plurality of openings 173 in the wicking basket 175 are small enough to prevent the soil or dirt from continuously escaping into the reservoir area 172.

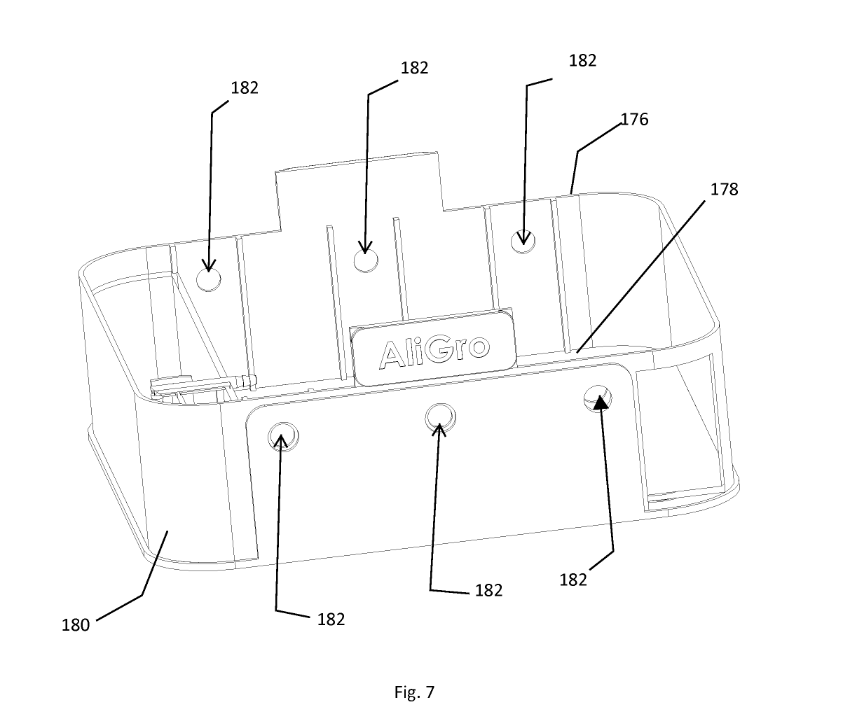

The grow module 114 further comprises a reservoir pan 176 that occupies the reservoir area 172 and removably attaches to the sidewall 154 of the housing 150. The reservoir pan 176 houses the watering system, such as a float valve 184 to control the flow of water, and an aerator 186 that oxygenates the water. As shown in FIG. 7, the reservoir pan 176 comprises a bottom plate 178 and a raised wall 180 connected to or formed with the bottom plate 178. Like the sidewall 154 of the housing 150, the raised wall of the 180 of the reservoir pan 176 can be made of multiple walls attached together or a single wall formed accordingly. The raised wall 180 may comprise an inlet 182 through which water is introduced. Preferably, the reservoir pan 176 comprises a plurality of inlets 182. Having a plurality of inlets allows the user to pick and choose which inlet to use, allows for interconnectivity with other grow modules, and the option of introducing various substances through the different inlets. Unused inlets can be sealed with a plug 230.

In some embodiments, a float valve 184 may be attached to the reservoir pan 176 at any of the inlets 182 to control a flow of the water into the reservoir pan 176. The float valve 184 controls the flow of the water based on the water level. Therefore, the inlet 182 is positioned along the raised wall 180 and/or sidewall 150 such that when the water level reaches a certain predetermined height, the float valve 184 shuts off the water flow coming through the inlet 182. This prevents the water level from exceeding a certain level. In the preferred embodiment, the inlet 182 and the float valve 184 are configured so that the water level does not rise above the divider 168. This way, the water level stays inside the reservoir area 172. However, since the wicking basket 175 is in the reservoir area 172, the water is able to reach the plants 10 by capillary action.

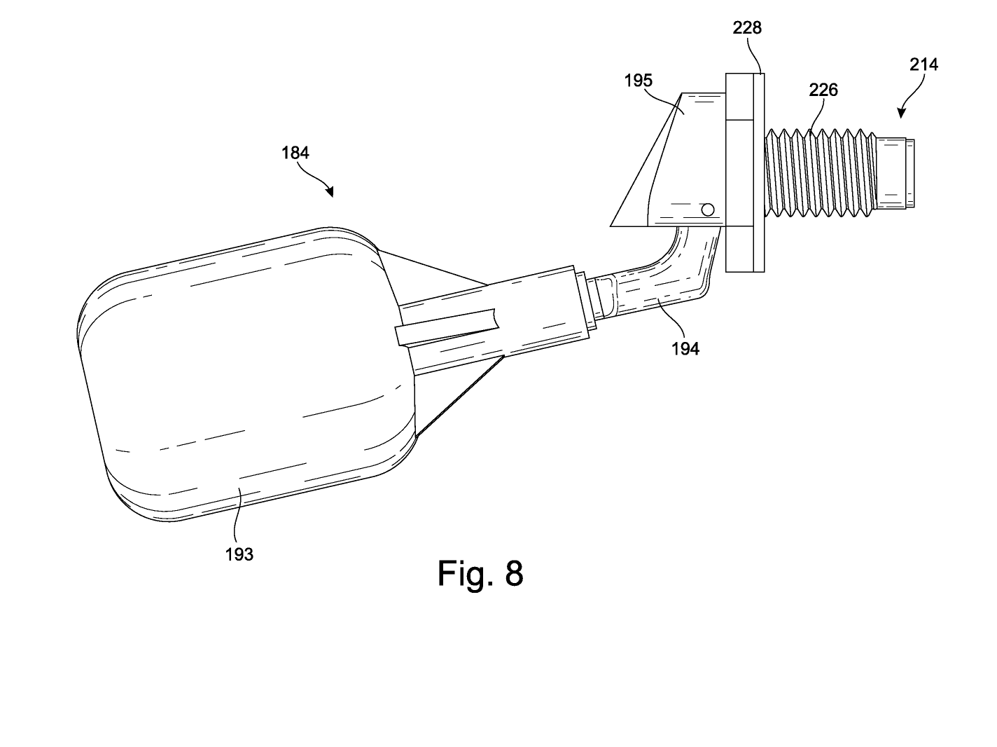

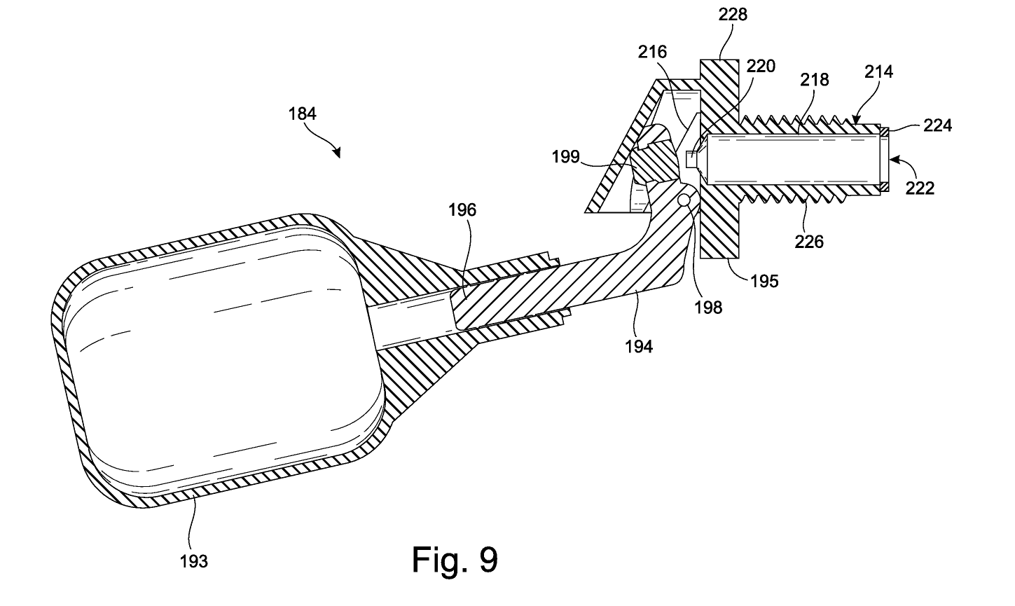

With reference to FIGS. 8 and 9, the float valve 184 is uniquely designed to fit quickly and easily into the inlet 182. In the preferred embodiment, the float valve 184 comprises a float 193, a valve arm 194 attached to the float 193, and a valve housing 195 attached to the valve arm 194 and insertable into an inlet 182. The float 193 can be any type of buoyant device that floats on water. The valve arm 194 has a first end 196 that can be attached to the float 193, and a second end 197 that is attached to the valve housing 195 at a hinge 198. This attachment allows the valve arm 194 to pivot about the hinge 198 as the float 193 is moved up and down. The second end 197 of the valve arm 194 also comprises a plug 199. The valve housing 195 comprises an inlet end 214 and an outlet end 216 in fluid communication through a channel 218. The outlet end 216 has a small hole 220 that can be completely covered by the plug 199. The inlet end 214 has a hole 222 into which tubing can be inserted to provide a water source.

In the preferred embodiment, the inlet end 214 further comprises a tube lock 224. The tube lock 224 is configured to quickly and easily lock tubing inside the channel 218 to provide a source of water through the float valve 184. For example, the channel 218 may have a gradual taper towards the inlet end 216. The tube lock 224 may also be similarly tapered so as to have a slight frustoconical shape with the narrower end external to the channel 218 and the wider end inside the channel 218. A spring may also be placed inside the channel 218 abutting against the wider end of the tube lock 224. This creates a biasing force against the tube lock 224, pushing the tube lock 224 out of the channel 218. However, due to the dimensions of the tube lock 224, it cannot be forced out of the channel 218 though the inlet end 214. The tube lock 224 may further comprise longitudinal slits intermittently and preferably evenly spaced around the tube lock 224. This allows the tube lock 224 to expand and contract. The tube lock 224 and the channel 218 are precisely dimensioned so that when the narrow end of the tube lock 218 is pushed towards the channel 218 the wider end is allowed to expand. When the tube lock 224 is released, the spring forces the tube lock 224 out of the channel 218, and due to the tapering, causes the wider end to shrink. In use, the user can push the tube lock 224 deeper into the channel 218 to expand the tube lock 224, then insert a piece of tubing into the tube lock 224. When the user releases the tube lock 224, the spring forces the tube lock 224 away from the valve housing 195 and the wider end of the tube lock 224 shrinks in size. This causes the tube lock 224 to clamp down on the tubing and lock the tubing in place.

In the preferred embodiment, the channel 218 is exteriorly threaded 226. Thus the channel 218 can be inserted through the inlet 182 with the float 193 on the inside of the reservoir pan 176. The inlet end 214 of the valve housing 195 will project out of the reservoir pan 176. A nut 277 can be used to screw onto the channel 218. A washer 228 may be used on one or both sides the inlet valve 182 to assure a water tight seal.

In some embodiments, an aerator 186 may be placed in the reservoir pan 176 to aerate the water. For example, an airstone may be used. An air pump 192 can supply air to the aerator 186.

In some embodiments, the reservoir pan 176 may comprise an auxiliary wall 188 spaced apart from but connected to the raised wall 180. The auxiliary wall 188 and the raised wall 180 defining a gap 190 therebetween. This gap 190 can be used to house electricals, power packs, pumps 192 and the like. Due to the wall configuration; however, these auxiliary equipment can be hidden from view.

Since the grow module 114 is an artificially created environment, soil is technically not necessary. Aside from providing certain nutrients, soil provides a stable foundation from which the plant can grow. However, if the nutrients are provided from a different source and the plant is supported by an artificial structure, the soil is not required. Without the soil, the user can actually see the roots of the plant. Based on the visual characteristics of the roots, the user is able to determine the condition or health of the plant. Therefore, in some embodiments, an alternate watering system may be provided that allows the plants to receive water and nutrients without the use of soil.

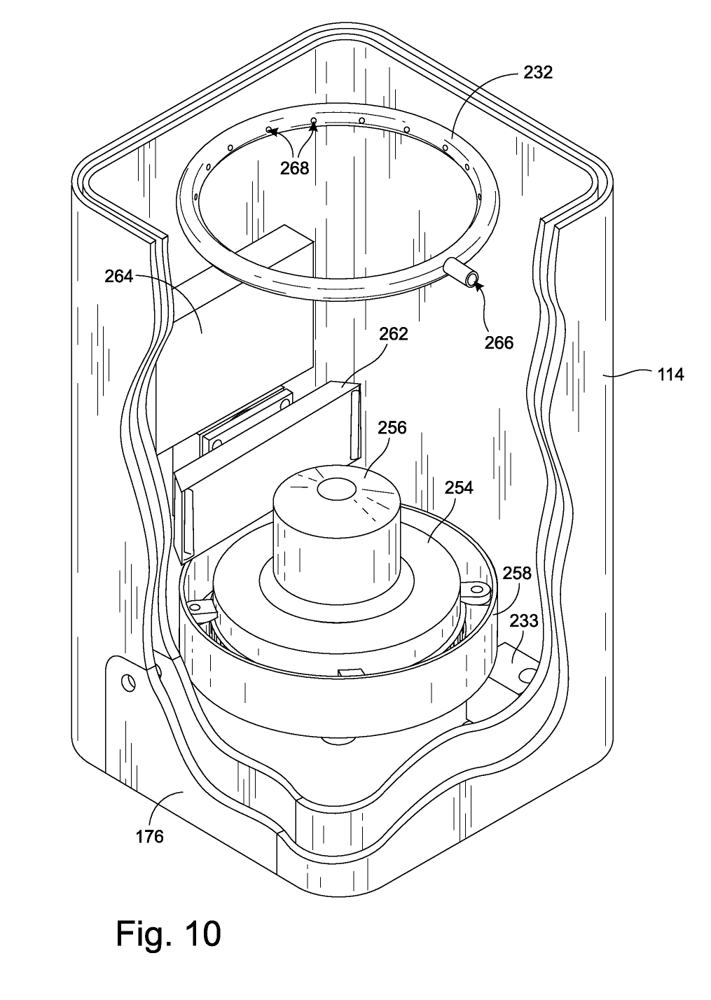

With reference to FIGS. 10-14, in a soil-less system, the grow module 114 can utilize the housing 150 and reservoir pan 176, and optionally, lid 162 and trellis 161, as described above. The soil-less system, however, utilizes a different watering system. Rather than relying on a body of water that can be taken up by capillary action through the soil/dirt, the soil-less system utilizes and an atomizer system 234, a sprinkler 232, or both. In the preferred embodiment, the atomizer system 234 is used as the primary source of water and nutrients and the sprinkler 232 functions as a backup should the atomizer system 234 malfunction.

In the preferred embodiment, fluid is introduced through a tube inserted through the inlet 182 of the reservoir pan 176 to fill the reservoir pan 176 with fluid. The atomizer system 234 comprises an atomizer 236, a flow generator 238, and a motor 240. The motor 240 drivers the atomizer 236, which receives fluid from the flow generator 238, such as an Archimedes' screw, an impeller, a pump, and the like. An example of an Archimedes' screw is shown in FIG. 13.

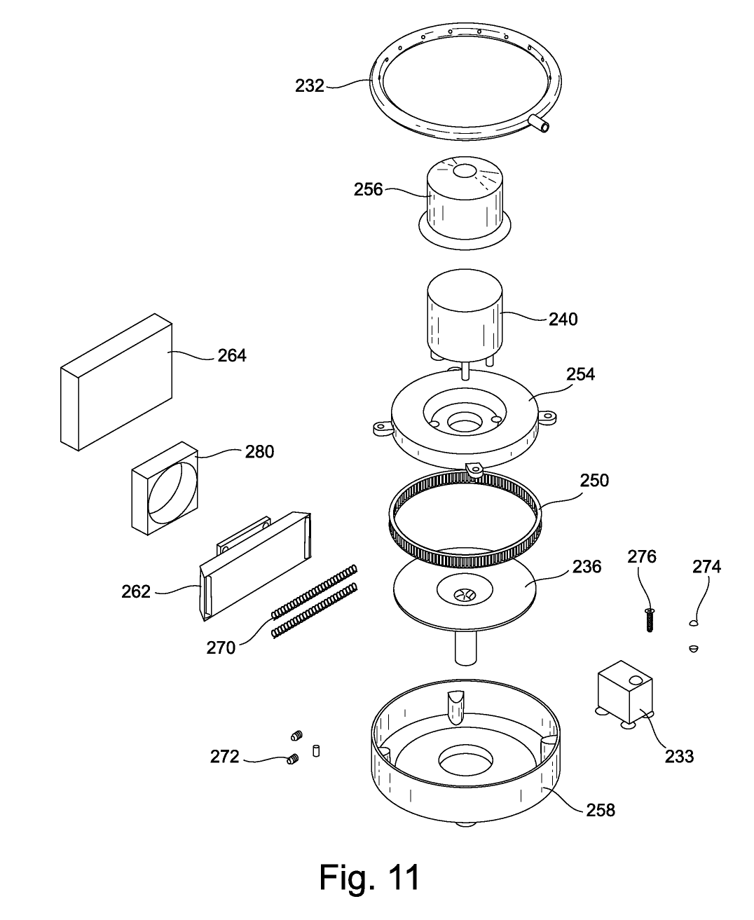

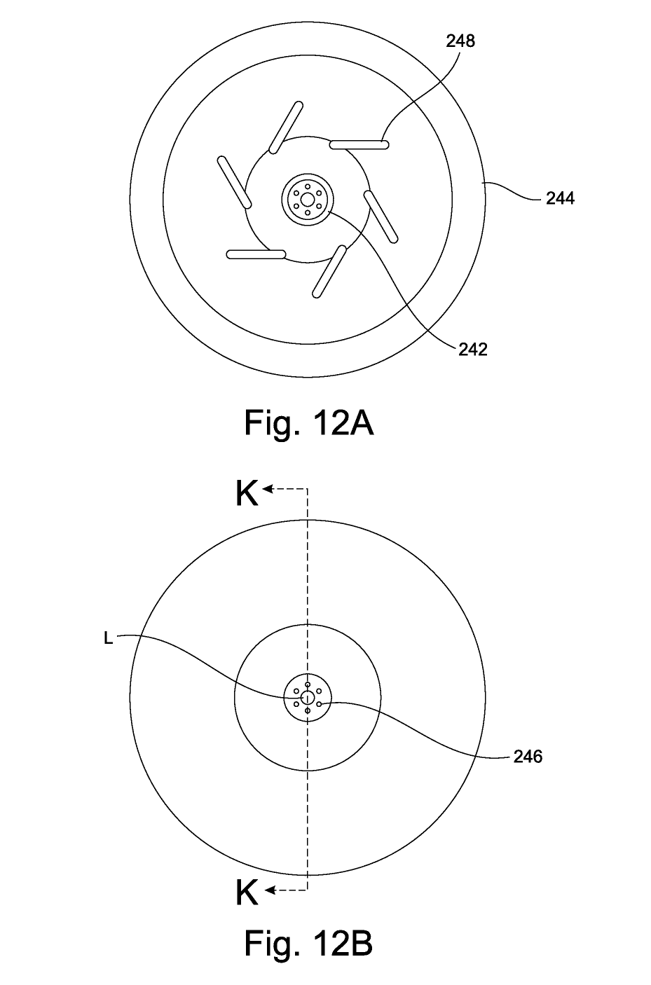

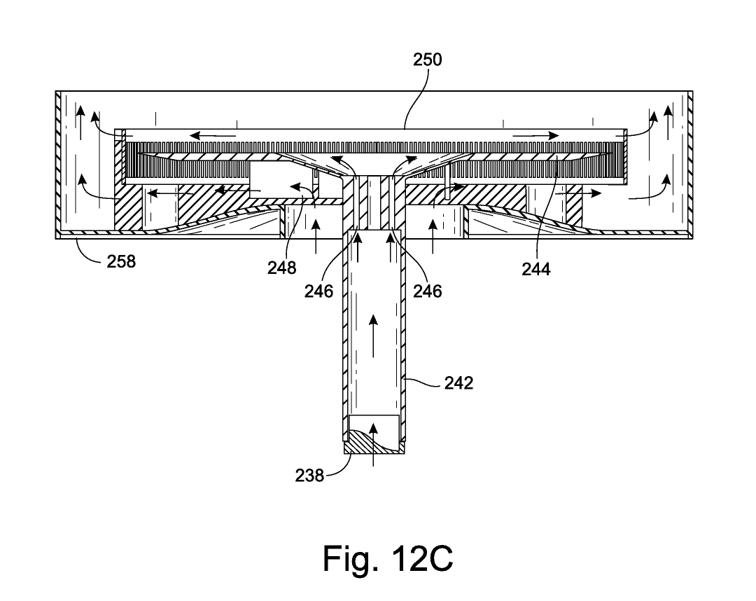

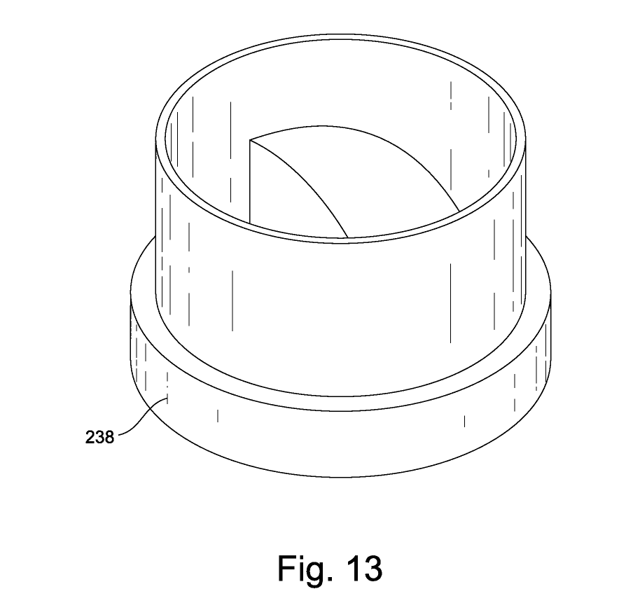

The atomizer 236 breaks the fluid into tiny droplets to form a mist. In the preferred embodiment, a centrifugal atomizer is used, as shown in FIGS. 11-12C. The centrifugal atomizer comprises a feed tube 242 attached to a disk 244. The feed tube 242 has one or more channels 246, and preferably a plurality of channels arranged off center from the longitudinal axis L of the feed tube 242. As shown in FIG. 12C, fluid flows into the feed tube 242 while the disk 244 and feed tube 242 are rotated at a high rate of speed. This causes radial forces to be applied to the fluid in the feed tube 242. As the fluid exits the feed tube 242, the fluid disperses and is projected radially outwardly as a mist.

In some embodiments, under the disk 244 may be a plurality of blades 248 that rotate with the disk 244. The rotating blades 248 function like a fan thereby creating airflow. Preferably, the air is drawn up from the bottom of the disk 244 then pushed upwardly and radially outwardly to carry the mist outwardly and upwardly towards the root zone, as shown in FIG. 12C.

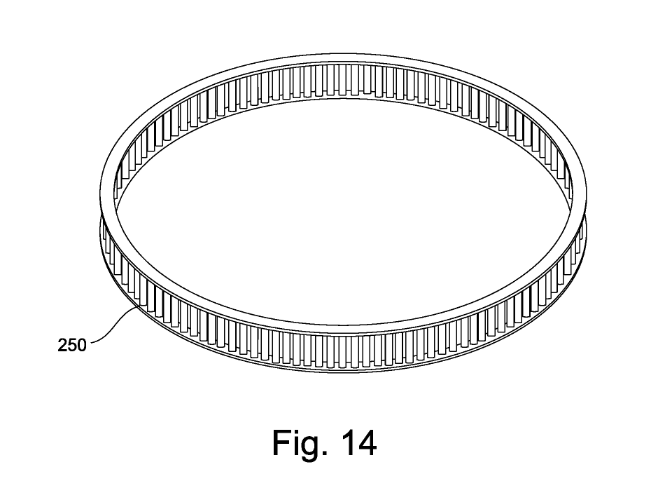

In some embodiments, a diffuser screen 250 may be positioned around the disk 244 so that the fluid passes through the diffuser screen 250 to further increase dispersion of the fluid mist. As shown in FIG. 14, the diffuser screen 250 may be ring-like structure with a plurality of small or thin openings 252. In the preferred embodiment, the openings may be approximately (170 mm wide. Each opening may be approximately 0.40 mm apart from each other.

The motor 240 may sit on top of a motor mount 254 and housed in a motor housing 256 for safety and protection. An atomizer housing 258 may hold the atomizer system 234. The atomizer housing 258 may have a central hole 259 through which the feed tube 242 of the atomizer 236 can be inserted. In some embodiments, a cooling fan 260 may be provided to blow on the motor 240 to control the temperature of the motor 240 and prevent overheating and/or blow the mist around the root zone 170. A fan duct 262 may be provided to direct the airflow directly on to the motor 240 and/or throughout the root zone 170. An electronics bay 264 may be provided to provide the electrical wiring to the various components. The electronics bay 264 may also comprise a controller 201 to control the various components.

In some embodiments, a sprinkler 232 is also provided. A pump 233 may be attached to the sprinkler to provide a source of water and nutrients. The sprinkler 232 is positioned in the root zone 170. The sprinkler 232 can be used in lieu of the atomizer 236, with the atomizer 236, or as a hack-up for the atomizer 236. For example, if the atomizer 236 malfunctions, the controller 201 may switch the water source to the sprinkler 232. In some embodiments, this is a temporary hack-up until the atomizer 236 is fixed.

As shown in FIG. 10, the sprinkler 232 is a tube-like structure comprising an inlet 266, and a plurality of outlets 268. In the preferred embodiment, the sprinkler is a ring-like structure with the inlet 266 positioned on the outside of the ring and the outlets 268 positioned on the inside of the ring. Therefore, the sprinkler is configured to spray radially inwardly. With the plant positioned on the inside of the ring, the sprinkler 232 is in the perfect position for evenly spraying water and nutrients to the plant's roots. A water pump 233, such as a submersible water pump, may be used to drive water through a tube connected to the inlet. 266 of the sprinkler 232.

Additional features that can be used with the grow module 114 include heating coils 270 to control the temperature of the environment or the fluids, and various types of sensors to assure that the optimal environment is provided for the plants. For example, the grow module 114 may include a water sensor 272 to detect the water level, a temperature sensor 274, such as a thermometer, thermistor, etc., and a moisture sensor 276, such as a hygrometer, to detect the humidity level. Thus, the precise atmospheric condition inside the grow module (for any embodiment described herein), can be precisely controlled, just like the atmospheric environment of a grow room. This may be done by a single controller 201.

In some embodiments, the grow modules 114 may utilize netted pots connected to, or hung within, the grow module 114 in the root zone 170 to securely hold plant seeds such that when the seeds sprout their roots spread through and outward from the netted pot and throughout the root zone, and soil, if any. In some embodiments, the netted pots may be placed in lids that are placed on top of the housing 150. Lids may be configured to allow the roots to grow into the housing 150. Each netted pot 160 may be of any size and shape. Multiple netted pots 160 may be connected to or hung within each grow module 114 in order to accommodate any number of plants or flowers in any arrangement or spacing configuration.

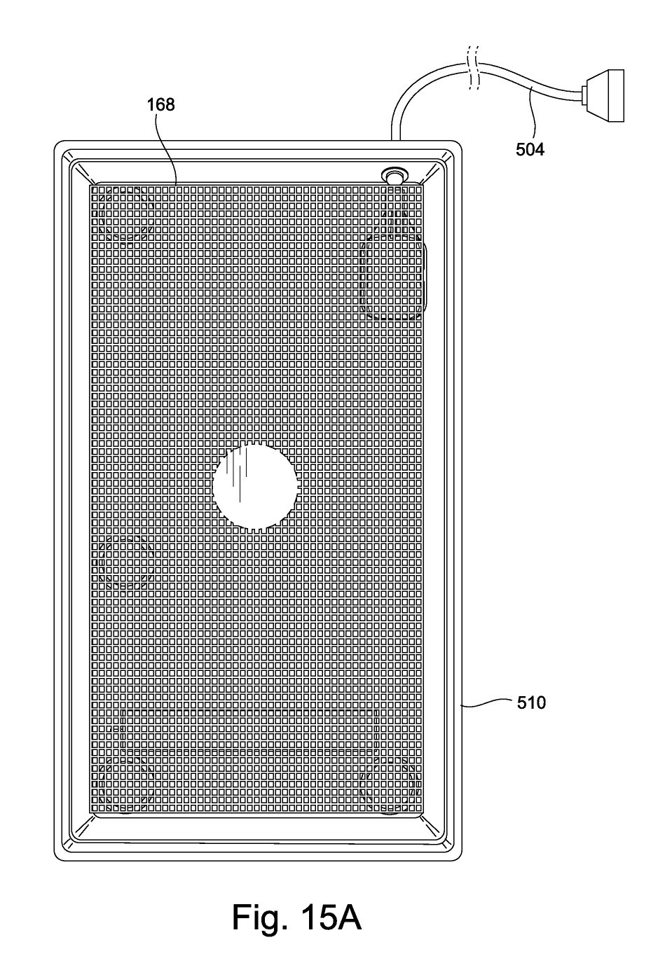

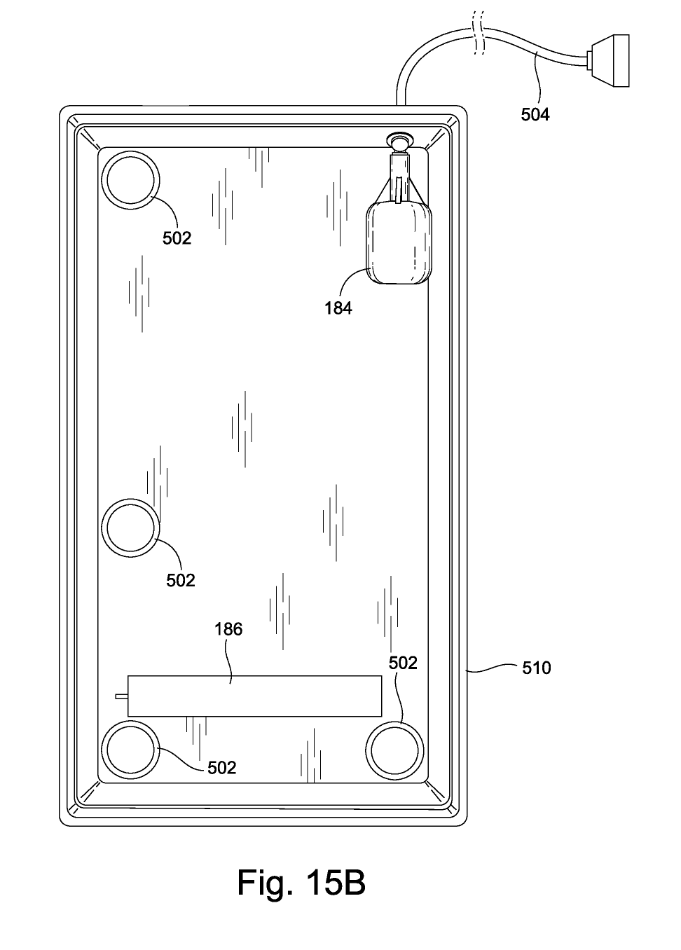

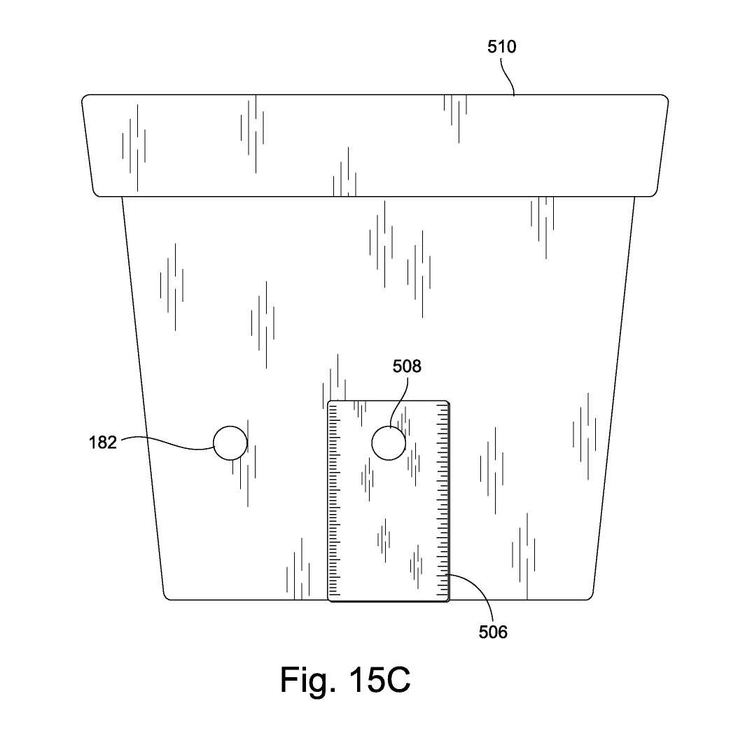

In some embodiments, a grow module kit may be provided for users to create their own makeshift grow module. As shown in FIGS. 15A-15C, the grow room kit comprises a divider 168, a plurality of supports 502, a float valve 184, tubing 504, and an aerator 186. The divider 168 can be the same as described above. In some embodiment, the wicking basket 175 may be integrally formed with the bottom surface of the divider 168 or it may be attachable to the bottom surface of the divider 168. In some instances, depending on the size of the planter, having the wicking basket 175 in a central location may not be feasible. Therefore, allowing the wicking basket 175 to be attachable improves the versatility of the divider by allowing it to fit in a variety of planters. Once the wicking basket's position is established, a hole 177 can be cut through the divider 168 above the wicking basket 175 to allow the soil and/or dirt to be placed in wicking basket 175.

In embodiments in which the wicking basket 175 is integrally formed with the bottom surface of the divider 168, the divider 168 can be cut in various ways so as to place the wicking basket 175 in the proper location.

In some embodiments, a measuring device 506 may be provided to help determine the proper level for creating the inlet 182. The measuring device 506 may come with a pre-cut hole 508. To use the kit, the user can get any planter 510. The measuring device 506 is placed on the ground against the planter where the inlet is to be created. The user need only trace the pre-cut hole 508 against the planter to create a mark where the inlet 182 will be created. The measuring device may be already dimensioned to place the inlet at the proper level. The supports 502 are also dimensioned properly so as to elevate the divider 168 at the proper height relative to the inlet. The divider may have to be trimmed to fit inside the pot 510. The inlet can be created with any appropriate tool. Once the inlet is created, the float valve can be installed by inserting the channel through the inlet from the inside so that the float remains inside the pot. The valve housing can be secured using a nut. The supports 502 can be placed along the periphery of the pot. The aerator can be placed anywhere. A second hole may be created for the connections for the aerator. The divider is then placed on top of the supports 502. The tube 504 can be inserted into the valve housing. The other end of the tube can be connected to a water source.

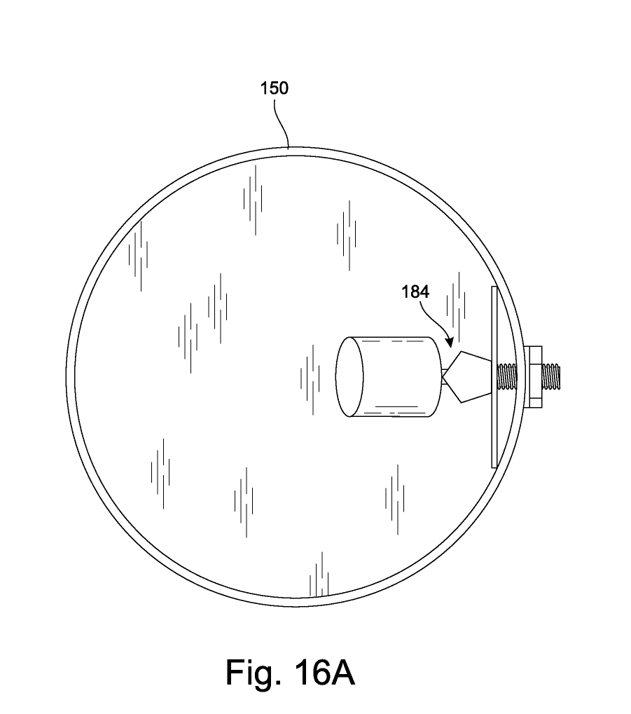

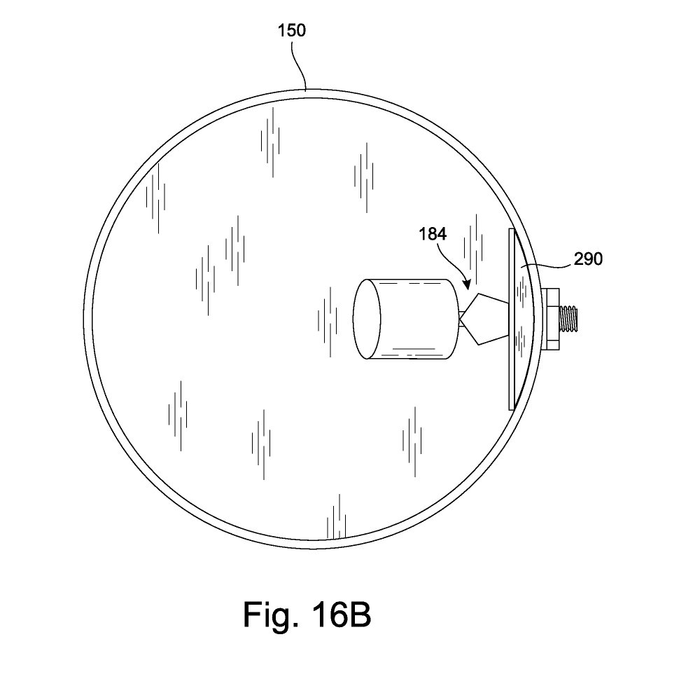

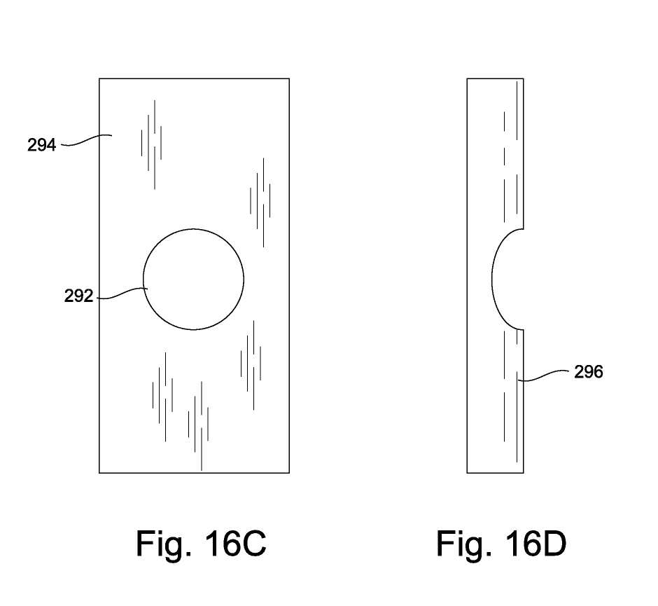

In some embodiments, the grow module 114 may be cylindrical in shape or a user may want to apply the kit to a cylindrical planter. In such situations, the float valve may not necessarily provide a water tight seal at the inlet 182 as shown in FIG. 16A. In such a situation, a wedge washer 290 may be used as shown in FIG. 16B. As shown in FIGS. 16C-16D, the wedge washer is a partially-cylindrical shaped washer. Essentially, the washer is a cylinder having a transverse hole 292 through the cylinder, then cut along a longitudinal plane so as to create a flat face 294 on one side and a curved face 296 on the opposite side. As shown in FIG. 16B, the channel 218 of the valve housing 195 is inserted through the transverse hole 292 with the flat face 294 abutting against the valve housing 195. The channel 218 can then be inserted through the inlet 182 from the inside to the outside. This causes the curved face 296 to abut against the curved wall of the cylindrical pot thereby creating a water tight seal. As such, the wedge washer 290 may be made from rubber, silicone, plastic, and the like.

Rotatable Lift System

In some embodiments, the grow module 114 may be used in conjunction with a rotatable lift system 102 upon which the grow module 114 can be mounted so that the plant can be positioned at an optimum distance from a light source 300. With the use of a sensor 200 operatively connected to the rotatable lift system 102, the rotatable lift system 102 rotates the grow modules 114 in a planetary path about a main axis A defined by the lift system 102. Simultaneously, the rotatable lift system 102 is capable of raising and lowering, via lift arms 110, each grow module 114 independently of any other grow module 114. In addition, each grow module 114 is capable of being rotated about its own axis. The rotatable lift housing 102 may be placed inside of a grow room configured to monitor and maintain the most optimal growing conditions for plants.

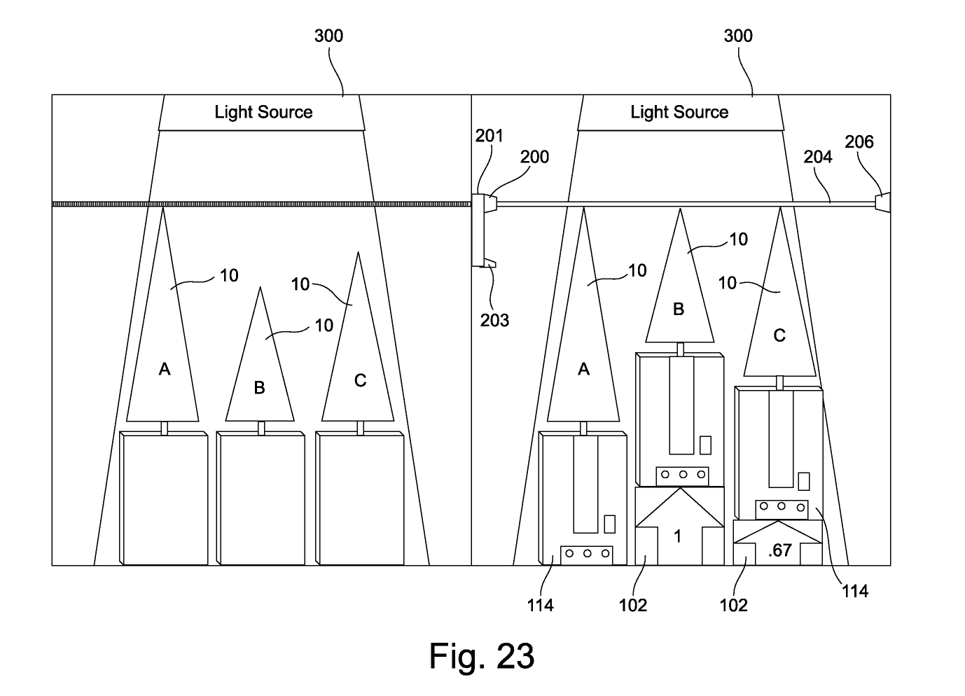

FIG. 23 shows a comparison of current plant growing systems (left side) and an embodiment of the present invention (right side). The same three plants of various sizes are depicted on both sides. Plant A is the tallest (1 foot away from the light source 300). Plant B is the shortest (2 feet away from the light source 300), and Plant C is of intermediate height (1.67 feet away from the light, source 300) compared to Plant A and Plant B. The left side depicts the plants in a typical scenario—level plane without a lift mechanism. The right side depicts the same plants atop of the lift system 102.

The shortcomings of the prior art is evident—the plants are not receiving the same amount of illumination from the light source. The inverse Square Law of Lighting demonstrates the critical need for a lifting apparatus for controlled environment horticulture. The formula is: illumination of an object (I) equals the inverse of the square of the distance (D) of an object from the light source (I=1/D)²).

Assume ideal illumination onto a plant when it is one foot away from the light source. At two feet, the illumination is one-fourth the ideal value. At three feet, the illumination is one-ninth the ideal value. With each foot of distance, the illumination decreases exponentially.

Applying this formula to the example in FIG. 23, we see Plant B (two feet from the light source) is receiving only one-fourth of the light intensity as Plant. A (one foot from the light source). Secondly, Plant B suffers from the shadowing caused by Plants A and C, so it has two distinct hindrances that hamper its ability to grow. Plant C is also suffering from a tremendous loss of light intensity as well because it too is not at the ideal one foot mark away from the light source. As the three plants continue through their lifecycles, Plant B and Plant C's respective distances from the light source will unfortunately grow further and further because of the light intensity being received by Plant A will facilitate growth that outpaces that of Plant B and C. The positive impact of Plant A receiving optimal light intensity is enormous. But at the same time, the consequence of not having each plant receive that same benefit is costly—the other plants under that light source will suffer from receiving fractional quantities of light and the effects of shadowing (which means plants receiving even less light.) Plant A's success becomes Plant B's and C's enemy. Plant A will produce generous yields, while Plants B and C lag utterly behind. A mere few inches translate to a lot of light loss, which translates to a lot of yield loss, which translates to a lot of cash loss. Note that simply lowering the lighting apparatus is not a solution because one can only lower the light, to the height of the tallest plant.

The individual lifting capability of the lift system 102, as depicted on the right side in FIG. 23, solves this problem by affording all the plants within a crop, Plant A's fortune. This eliminates the loss of intensity and shadowing. The lift system 102 ensures each and every plant receives equal light intensity and even light exposure regardless of the size of plant or its position under the light source, and therefore, increasing crop yields exponentially at a savings to the crop owner. Having a whole crop of champions, not just one featured star followed by a set of mediocre performers, is every grower's dream. Growers/investors who value a high volume of high quality product on a highly consistent basis will respect and appreciate the lift system 102.

A “rotating turntable” or “plant mover” helps resolve the issue of “hot spots” and shadows, which are created by the light source, its reflective hood, grow room lighting configuration and/or by other considerations. By rotating the plants, a turntable ensures that plants share equal time in such hot spots, which is necessary, b does absolutely nothing about the intensity of light afforded to each individual plant. By lifting the plants to absorb the maximum energy allowance of the light source—or to the highest point tolerable by a specific plant/lower—while rotating them and then n maintaining that distance, a grower achieves prime reward from the energy for which he/she is paying. When evaluating yields and monetary returns pertaining to investments/crops of pharmaceutical the advantages of the system creates a remarkable return on investment that is unparalleled or unachievable by other techniques or technologies.

An optic sensor 200 working in cooperation with the lift device can be used to raise a plant to an ideal height in relation to the light source 300 and maintain that plant-to-light distance by gradually lowering the lift plate as the plant grows. This prevents the laborious task of continuously needing to raise/lower one's plants to receive the full benefit of the energy being provided by the light source.

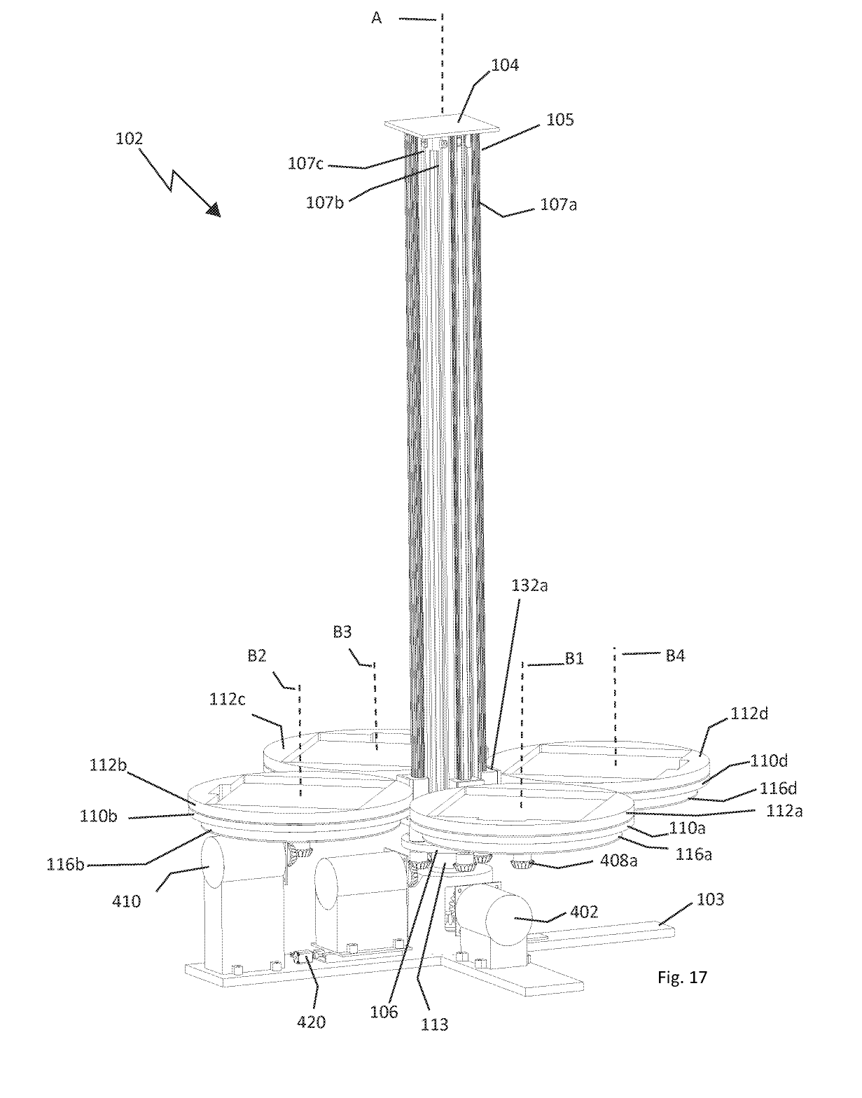

As shown in FIG. 17, in the preferred embodiment, the lift system 102 comprises a tower 105 defining a main axis A, the tower 105 connected to a base 103 to allow the tower 105 to rotate about, its main axis A, using a system of gears.

In the preferred embodiment, the tower 105 is perpendicular to the ground when properly mounted on its base 103. The tower 105 comprises a top 104, a bottom 106 opposite the top 104, and at least one sidewall 107a-d therebetween connecting the top 104 to the bottom 106. The main axis A is perpendicular to and passes through the top and bottom 104 and 106, preferably at their respective centers.

The bottom 106 is attached to the base 103 in a rotatable manner, for example, by being rotatably mounted on a post 113 on the base 103. Thus, the bottom 106 of the tower 105 may function as a turntable or a lazy susan, which is rotatably coupled to the base 103. The tower 105 may be a polyhedron of any shape, including, by way of example only, a cylinder, a triangle, a rectangle, a hexagon, an octagon, and the like.

In other embodiments, only the sidewalk of the lift housing 102 may be rotatable about the main axis A. Other embodiments may also utilize a roller system, in which high friction rollers, or wheels, may be used to rotate the bottom 106 about the main axis A from below and/or along the side of the bottom 106. Rollers may also be positioned adjacent to the periphery of the bottom 106 to provide additional support.

Each sidewall 107a-d may be lined with a track 130a-d. Each track 130a-d may have a lift device 132a-d that rides vertically up and down along the track 130a-d. Each track 130a-d can line substantially the full length of the sidewall 107a-d. The tracks 130a-d may be any type of linear rail or toothed track that utilizes gears, spiral screws, lead screws, pulleys, hydraulic lifts, and the like to move the lift device 132a-d, such as a truck or carrier, in a vertical direction upon rotation of lift gears 404a-d.

Attached to the tower 105 is a plurality of support assemblies that hold the grow modules 114 as the grow modules 114 are lifted and rotated about. In the preferred embodiment, each support assembly is essentially identical, comprising lift arms 110a-d, lift plates 112a-d, and plate gears 408a-d; therefore, only one will be described, but the description applies to all of the support assemblies.

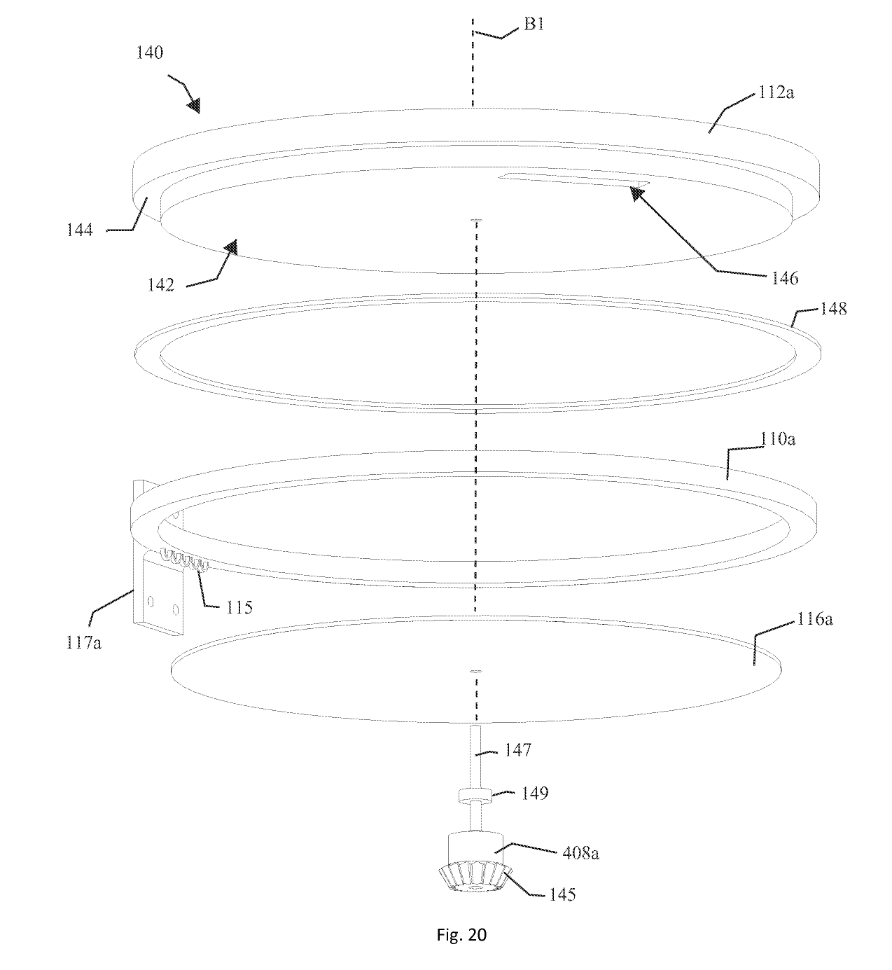

With reference to FIG. 20, the support assembly comprises a lift arm 110a attached to one sidewall 107a, the lift arm 110a configured to move in a vertical manner independently of another lift, arm along its respective sidewall. The lift arm 110a is used to support a lift plate 112a. In the preferred embodiment, the lift arm 110a is a ring-like structure attached to a mounting bracket. 117a. The mounting bracket. 117a is configured to attach to the lift device 132a. Thus, as the lift device 132a moves up and down along its track 132a, the lift arm 110a moves with it. The shorter a plant is, the closer the plant will need to be to the light, source 300. As each plant grows within its respective grow module 114 it will be lowered from the light, source 300 via the lift, arm 110a to maintain the optimal distance from the light source 300. Furthermore, the lift arm 110 may assist with directing, routing, and concealing electrical wiring and tubing for water, nutrients, air supply, and run-off. Therefore, in some embodiments, the lift arm 110a may comprise wire management members 115. The wire management member 115 may be a series of loops, hooks, clips, and the like to manage any wires, tubing, cords, and the like that may be utilized by the grow module 114 so as to minimize tangling and kinks.

Mounted on the lift arm 110a is a lift plate 112a. The lift plate 112a, which hold the grow modules 114, may be raised and lowered toward and away from a light source 300 while the lift plates 112 maintain a parallel relation to the ground. In addition, the lift plates 112a-d revolve around the tower 105, while at the same time rotating about their own axes B1-B4.

In the preferred embodiment, the lift plate 112a is a disk-like plate having a top surface 140 and a bottom surface 142. The top surface 140 may comprise a recess similar in shape to the grow module 114 so that the grow module 114 can be seated securely in the lift plate without sliding off during the revolution, rotation, or vertical movement actions. The dimension of the bottom surface 142 is slightly smaller than the dimension of the top surface thereby creating a lip 144 on the bottom side. The bottom surface is also dimensioned to be substantially similar to the inner side of the lift arm 110a so as to fit inside the lift arm 110a. The lip 144 then abuts against the top side of the lift arm 110a with the bottom surface residing within the ring of the lift arm 110a to allow the lift plate 112a to rest on top of the lift arm 110a. An opening 146 may be created through the top and bottom surfaces 140, 142 to allow any wire, tubing, or cords to pass through from the bottom surface 142 to the top surface 140 to connect with a grow module 114 sitting atop of the lift plate 112a.

A plate gear 408a is operatively connected to the lift plate 112a preferably at its center. The plate gear 408a comprises gear teeth 145 attached to a spindle 147. The spindle is attached to the bottom surface 142 of the lift plate 112a such that rotation of the gear teeth 145 causes rotation of the spindle 147, which causes rotation of the lift plate 112a. In some embodiments, to facilitate the rotation of the lift, plate 112a-d, a low friction interface 148 may be positioned in between the lift plate 112a-d and the lift arm 110a. In the preferred embodiment, the low friction interface 148 is in the form of a Teflon ring having dimensions substantially similar to that of the lift arm 110a-d.

In some embodiments, along the spindle 147 may be a protrusion 149 that can function as a stop. In some embodiments, a guard 116a may be inserted in between the lift plate 112a and the protrusion 149, such that the guard is mounted on the protrusion 149 beneath the lift plate 112a with a gap therebetween. As the lift plates 112 revolve about the tower and rotate about their own axes in a clockwise and counterclockwise manner, the tubes and wires entering into the grow modules may get tangled. The guard 116a reduces the possibility of tangling and getting caught in the gears.

In some embodiments, the lift arm 110 may fit into and be attached to the lift housing 102 via an opening on the sidewall 107 of the lift housing 102 that may extend the vertical length of the lift housing 102. In some embodiments, the lift arm 110 may be attached to the sidewall 107.

The lift arm 110 may be of many different forms. In some embodiments, the lift arm 110 may be elevated on a track 130 inside the side wall opening 109 or on the sidewall 107, and rigidly connected to the lift plate 112 such that the lift arm 110 and lift plate 112 are in a parallel relation to each other, as well as to the ground, in order to keep the lift plate 112 level. The lift arm 110, in other embodiments, may also be elevated via a pulley, spiral, or hydraulic lifting system, or the like, located inside the sidewall opening or on the sidewall 107 of the lift housing 102. Other embodiments of the lift arm 110 may include an articulating lift arm 110 located within the sidewall opening 109 or on the sidewall 107 of the lift housing 102 where a first joint exists between a first end of the lift arm 110 and the lift plate 112 and a second joint exists between a second end of the lift arm 110 and the lift housing 102 so that the lift plate 112 does not have to follow the rigid movements of the lift arm 110. The joints in this embodiment are utilized to control the movement of the lift plate 112 by ensuring the lift plate 112 maintains a flat and level surface so the grow module 114 it supports is not disturbed. This embodiment may be used with or without a track, pulley, spiral, or hydraulic lift system, or the like.

In the preferred embodiment the rotation of the lift housing 102 may be automated with the use of a gear system operatively connected to a controller 201, to cause the tower 105 to rotate about its main axis A in either a clockwise or counterclockwise direction. The gear system may be located directly on or below the bottom surface 106 of the tower 105.

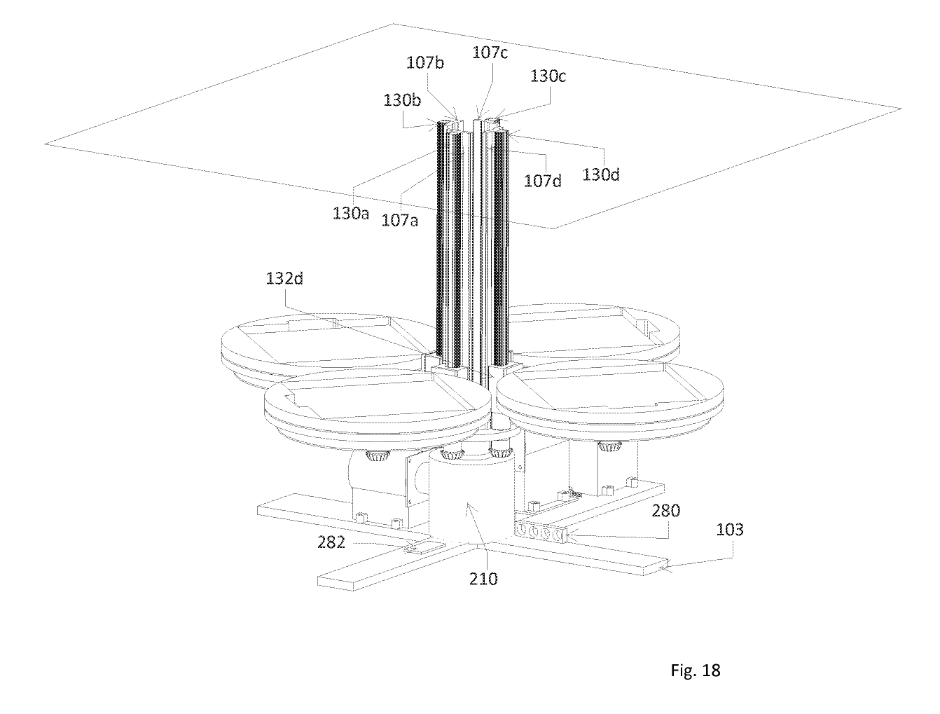

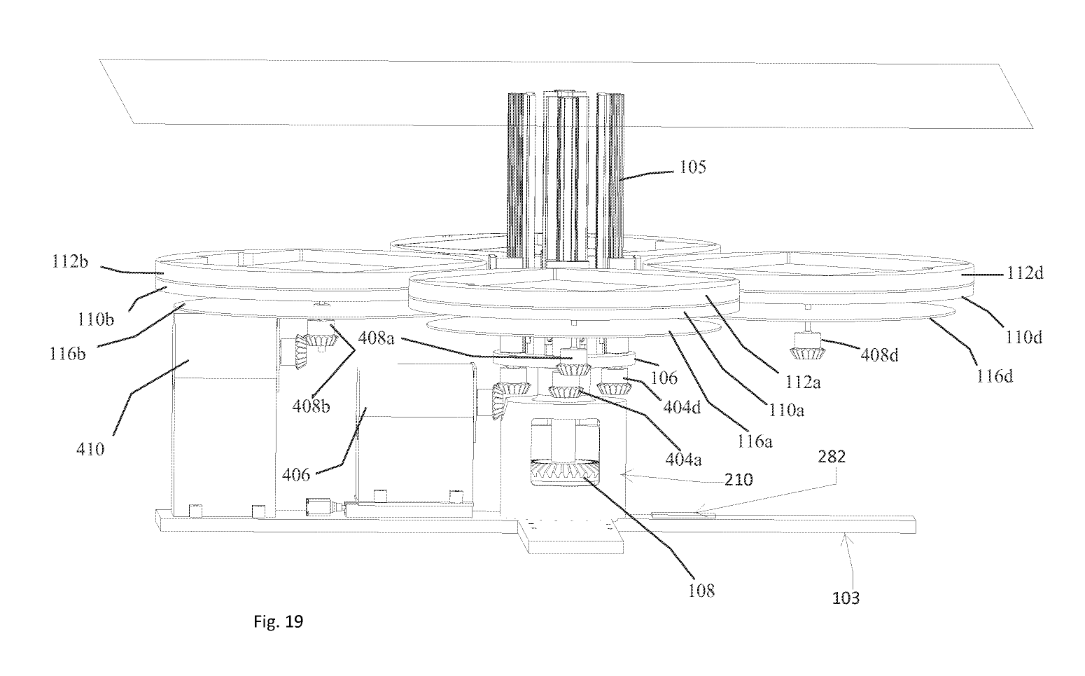

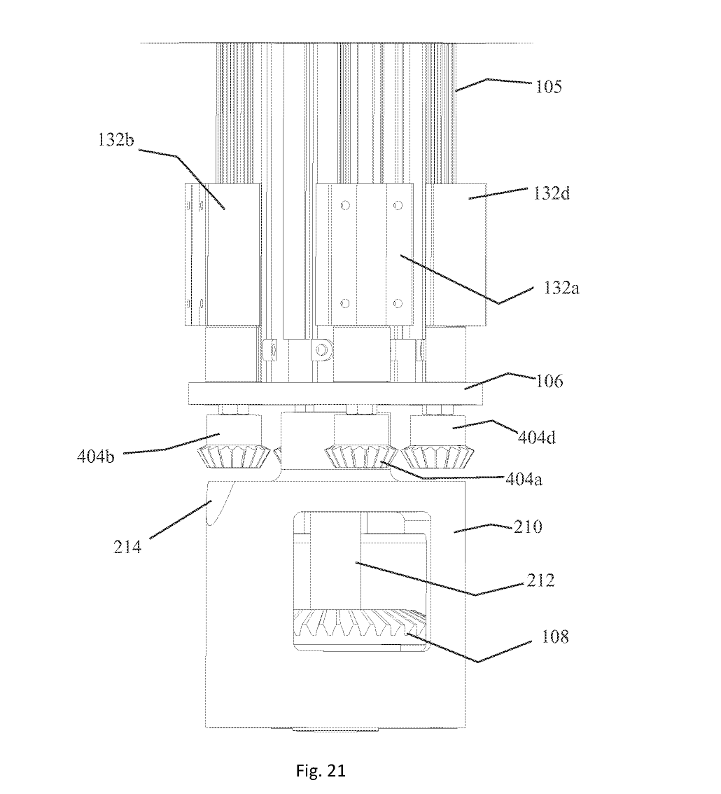

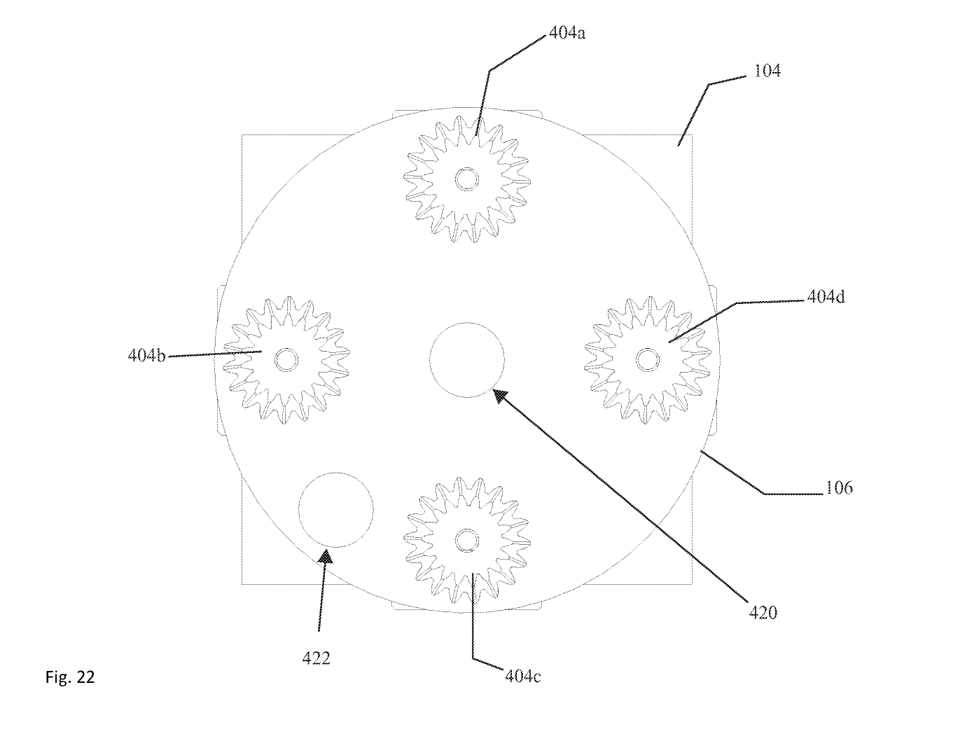

With reference to FIGS. 17-22, in the preferred embodiment, the gear system comprises three motorized gears 402, 406, 410, a central gear 108 that causes the lift plates 112a-d to revolve around the tower 105, a plurality of lift gears 404a-d to cause the lift plates 112a-d to move vertically up and down, and the plurality of plate gears 408a-d discussed above.

The central gear 108 is operatively connected to the bottom 106 of the tower 105, wherein rotation of the central gear 108 causes rotation of the tower 105 about the main axis A. For protection, the central gear 108 may be housed in a covering 210. A first motorized gear 402 is operatively connected to the central gear 108, the operation of which causes the central gear 108 to rotate. The first motorized gear 402 may be fixed to the base 103. Rotation of the central gear 108 causes its associated post 113 to rotate. The post 113 is connected to the tower 105 thereby causing the tower 105 to rotate.

A plurality of lift gears 404a-d are attached to the bottom 106 of the tower 105. One lift gear 404a-d is operatively connected to one lift arm 110a-d via its respective lift device 132a-d, such that rotation of the lift gears 404a-d causes vertical movement of the respective lift device 132a-d, and therefore, the lift arms 110a-d. A second motorized gear 406 is operatively connectable to each lift gear 404a-d, such that when one of the lift gears 404a-d is operatively connected to the second motorized gear 406, operation of the second motorized gear 406 causes the operatively connected lift gear 404a-d to rotate.

In the preferred embodiment, the second motorized gear 406 is fixed on the base 103. Since the lift gears 404a-d are connected to the bottom 106 of the tower 105, the lift gears 404a-d rotate with the tower 105. Rotation of the tower, then causes different lift gears 404a-d to engage with the second motorized gear 406. Thus, each lift gear 404a-d can be rotated by the second motorized gear 406 in turn. At the area where the second motorized gear 406 connects with one of the lift gears 404a-d, the cover 210 may be faceted 214 to allow the second motorized gear 406 to be as close to the cover 210 as possible. This improves the economy of space. In some embodiments, each lift gear 404a-d could have its own motorized gear 406 so that each lift arm 110a-d can move simultaneously with the others if necessary. However, as plants grow slowly, this is not necessary.

A plurality of plate gears 408a-d may be attached to the bottom of the lift plates 112a-d, one plate gear operatively connected to one lift plate, wherein rotation of one plate gear causes rotation of the respective lift plate. A third motorized gear 410 is operatively connectable to each plate gear 408a-d, such that when one of the plate gears 408d is operatively connected to the third motorized gear 410, operation of the third motorized gear 410 causes the operatively connected plate gear 408b to rotate, which causes the lift plate 112b to rotate.

The base 103 may comprise a wire management device 280 to manage the various wires, tubing, cords, and the like. The base may also comprise the controller 282 that controls the various features of the present invention.

At least one grow module 114 is situated on top of a lift plate 112. Each lift plate 112 is subsequently attached to the lift housing 102 via a lift arm 110. In some embodiments, within the lift housing 102 a separate motor or hydraulic pump is housed capable of raising and lowering each grow module 114 independently via the lift arm 110 and lift plate 112 combination. Each lift arm 110 may be guided along a flexible toothed track 130 so that the lift plate 112 may be raised and lowered in a smooth fashion in order not to disturb the grow module 114 it is supporting.

In some embodiments, the lift arm 110 and lift plate 112 may further serve as a means for routing power, water, air supplies, nutrients, and run-off between the lift housing 102 and the independent grow modules 114. A hollow tunnel through the interior of the lift arm 110 and lift plate 112 may be able to enclose and route electricity via a power supply from the lift housing 102 to each grow module 114 so that each grow module 114 may be independently operated. The lift arm 110 and lift plate 112 may also be capable of enclosing and routing multiple independent hoses via a second hollow tunnel so that water, air supplies, nutrients, and run-off may be pumped between the lift system 102 and the grow modules 114 from various reservoirs.

In some embodiments, the lift system 102 may also comprise a plurality of controllers and/or monitors to automatically optimize the conditions for plant growth in each grow module 114. A lift and rotation controller may be used for controlling an individual plate's movements, a flow meter for ensuring consistent water and nutrient supply, a pH tester and monitor, a nutrient dosing controller for automated feeding, a digital grow calendar display, a water temperature gauge for monitoring and regulating water temperature, air distribution vents for controlling air intake and outtake, carbon dioxide distribution vents for controlling carbon dioxide levels, a reservoir water level monitor for maintaining consistent reservoir levels, a fill/drain controller, and/or a leaf sensor to monitor a specific plant to determine whether it is receiving adequate or too much water and other nutrients. Each of these sensors and controllers can feedback to the system to make the necessary adjustments. In some embodiments, the sensors may feed into a single controller.

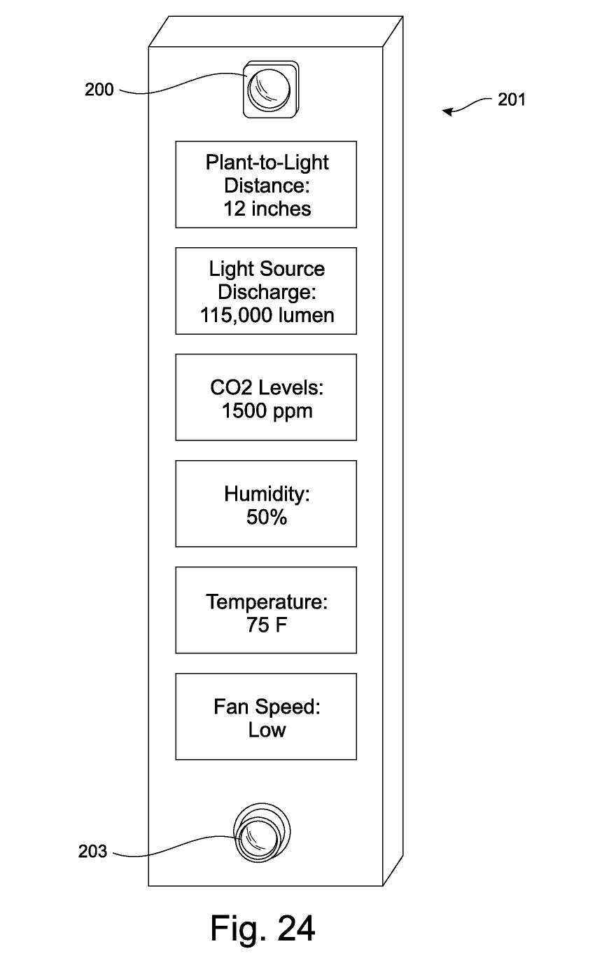

As shown in FIG. 24, a sensor 200 may be mounted upon or integrated with a controller 201 placed at the optimal distance below the light source 300 and operatively connected to the lift housing 102 and each lift arm 110, and may be capable of determining when the lift plate 112 has reached the appropriate height to optimize the distance between the plant and the light source so as to maximize the plant or flower's growth potential.

For example, as shown in FIG. 23, the sensor 200 may output a beam 204 that is transmitted to a receiver 206. The lift housing 102 rotates the grow modules 114 such that each plant passes directly under the sensor beam 204. The lift housing 102 and lift arms 110 continue to raise each lift plate 112 and grow module 114 until the plant it supports crosses and interrupts the beam 204 by blocking the beam 204 from getting to the receiver 206 from the sensor 200. Once the beam 204 has been blocked by a particular plant, a signal is sent to the controller 201 of the lift housing 102, and that plant's lift arm 110 will stop lifting and subsequently begin to descend until the beam 204 is able to be detected by the receiver 206. Once the receiver 206 detects the beam 204 again the particular lift arm 110 holding the plant that originally interrupted the beam 204 will stop lowering and remain in that position until its plant breaks the beam 204 between the sensor 200 and the receiver 206 again, in which case the lift arm 110 will repeat this process.

In another embodiment, in order to allow for plant growth, a recalibration may take place periodically, (e.g. once every 12 hours). During the recalibration each lift arm 110 and lift plate 112 is lowered to the lowest possible setting and then re-raised up until the plant or flower interrupts the sensor beam 204 from being received by the receiver 206 again. Upon interruption of the sensor beam 204 the lift arm 110 and lift plate 112 move down slightly until the beam 204 reaches the receiver 206 again and are held at that location until the next calibration. Each lift housing's sensor 200 may be programmed to recalibrate at a different time depending on what type of plant, flower, or crop is being grown.

By way of example only, the sensor 200 may be an optic or touch sensor and may relay an infrared, a photoelectric or a laser beam to a receiver 206.

As shown in FIG. 24, the plant growing system further comprises a controller 201 to control the activity required to maintain optimum growth of the plant. The lift system 102, grow module 114, and grow room may have separate controllers, or they may all be integrated into a single controller. If separate controllers, each controller should be capable of communicating with each other. Continuously monitoring grow room conditions and making necessary adjustments in real time is absolutely essential to maintaining an accelerated growing environment. The system's controller may 1) maintain plants at the ideal plant-to-light distance, 2) continuously measure grow room variables, 3) report the data to the grower, 4) allow changes remotely, 5) record every action taken by the grower, and 6) store and process the grow room data and grower actions for automated uploading at a later date and/or between systems to recreate the growth cycle minute-by-minute, action-for-action.

By way of example only, the controller 201 may include, but is not limited to, a recording system, a digital camera 203 (with time lapse photography feature) for monitoring, relaying, and communicating a live digital image or feed for viewing and/or security; a thermostat for measuring, relaying, and controlling air temperature; a hygrometer for measuring, relaying, and controlling relative humidity; a carbon dioxide sensor for regulating and relaying carbon dioxide levels; a light timer for lighting control thus allowing the grower to pre-program light times; an optic sensor for maintaining ideal plant-to-light distances; a lumen sensor for measuring, relaying, and controlling light source discharge; and a communication module for controlling and providing power and data signals between each unit on the controller 201 and the grow module 114 and/or the lift system 102, as well as sending information to users, investors, and the like. Other embodiments of the controller 201 may include a synchronization controller for “daisy chaining” units together in order to maintain similar conditions between various units. The detection, control, and optimization of the parameters discussed above can occur within the grow modules 114 and/or in the grow room in general. Thus, the grow room may have the various sensors so that the controller can control the humidity, temperature, carbon dioxide levels, etc. of the room itself. Thus, the controller 201 can monitor and control the micro-environment of the grow module as well as the macro-environment of the grow room in which the grow modules reside.

The controller 201 allows the user to monitor and record data for the different variables associated with the growing of the plans, such as watering information, temperature information, revolution information, rotation information, lighting information, lift information, nutrient, information, and the like. By monitoring and recording all variables, the user is able to correlate which conditions produced the best results. The user can also input data for each plant into the controller. By identifying the plant with the best result, the user can determine the best conditions. These conditions can be stored as a file that can be read and run as a program by the controller for the next similar plant. Having the controller run a program that created conditions that produced great results in one plant should produce similar results in a similar plan. Therefore, the next time a user plants the same type of plant for which be obtain great growing results, he can simply upload the same program to get the same results.

An application, or “app,” may be created for portable or mobile devices such as, by way of example only, a laptop computer, tablet, or cell phone that allows a user to monitor, receive, and control all aspects and features of the controlled environment agricultural system of the present invention while away from the physical unit. The application may send line feeds, or pictures of these plants and their environment. In some embodiments, a website may be established for the user to log-in and monitor his plants. Tools on the app will allow the user to move the camera or view from multiple cameras simultaneously or one-by-one. Additional tools allow the user to change or modify any of the features described above. A GPS unit may also be placed on the system to track its location.

Multiple controlled environment agricultural systems, as substantively described herein, may housed in a common grow room. Collectively housing multiple controlled environment agricultural systems in one room allows for common monitoring systems to be used including, by way of example only, a single thermostat, a single hygrometer, a single carbon dioxide sensor, a single communication module, and the like. A solar panel may be installed on the grow rooms so as to power the system using solar power.

The components of the grow module 114 and the lift system 102 can be made from metal, plastic, wood, glass, rubber, and the like.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A plant growing system, comprising:
a. a rotatable lift housing, the rotatable lift housing comprising:
i. a base,
ii. a tower operatively connected to the base, the tower comprising a top surface, a bottom surface opposite the top surface, and a plurality of sidewalls therebetween connecting the top surface to the bottom surface, the tower defining a main axis perpendicular to and passing through the top and bottom surfaces, the bottom surface attached to the base in a rotatable manner,
iii. a plurality of lift arms, one lift arm attached to one sidewall, each lift arm configured to move in a vertical manner independently of another lift arm along its respective sidewall,
iv. a plurality of lift plates, each lift plate defining a central axis parallel to the main axis, one lift plate attached to one lift arm, wherein the lift plates revolve about the tower in a planetary path, each lift plate configured to rotate about their respective central axis,
v. a central gear operatively connected to the bottom surface of the tower, wherein rotation of the central gear causes rotation of the tower about the main axis,
vi. a first motorized gear operatively connected to the central gear, operation of which causes the central gear to rotate,
vii. a plurality of lift gears, one lift gear operatively connected to one lift arm, wherein rotation of the lift gears cause vertical movement of the respective lift arms,
viii. a second motorized gear operatively connectable to each lift gear, wherein when one of the lift gears is operatively connected to the second motorized gear, operation of the second motorized gear causes the operatively connected lift gear to rotate,
ix. a plurality of plate gears, one plate gear operatively connected to one lift plate, wherein rotation of one plate gear causes rotation of the respective lift plate,
x. a third motorized gear operatively connectable to each plate gear, wherein when one of the plate gears is operatively connected to the third motorized gear, operation of the third motorized gear causes the operatively connected plate gear to rotate;
b. a plurality of grow modules positionable on top of the lift plate, wherein each grow module comprises a housing, the housing comprising:
i. a sidewall, wherein at least a portion of the sidewall is a dual panel sidewall comprising an inner wall and an outer wall surrounding the inner wall, the inner wall defining a main cavity, wherein at least a portion of the dual panel sidewall is transparent,
ii. a chute formed in the sidewall for depositing nutrients into the housing from outside of the housing,
iii. a segmented lid, comprising a first lid piece and a second lid piece, wherein the first lid piece defines a slot, into which the second lid piece is inserted to fully assemble the segmented lid, wherein the fully assembled segmented lid defines a grow hole;
iv. a telescoping trellis housed in between the inner wall and the outer wall of the dual panel sidewall, and extendable above the segmented lid,
v. a divider separating the main cavity of the housing into a root zone and a reservoir area, the divider comprising a wicking basket, a plurality of small holes, a main opening leading into the wicking basket,
vi. a reservoir pan occupying the reservoir area and removably attached to the sidewall, the reservoir pan comprising a bottom plate and a raised wall connected to the bottom plate, the raised wall comprising an inlet through which water is introduced,
vii. a float valve attached to the reservoir pan through the inlet to control a flow of the water into the reservoir pan, wherein control of the flow of the water is dependent on a water level,
viii. an aerator positioned in the reservoir pan,
ix. an auxiliary wall spaced apart from but connected to the raised wall defining a gap therebetween,
x. an air pump housed within the gap between the raised wall and the auxiliary wall, the air pump operatively connected to the aerator;
c. a sensor mounted upon a controller placed at an optimal distance below the light source and operatively connected to the lift housing, capable of determining when the lift plate has reached the appropriate height to optimize a distance between a plant and a light source so as to maximize the plant's growth potential; and
d. a controller operatively connected to the sensor, the first motorized gear, the second motorized gear, and the third motorized gear, wherein the controller operates the first motorized gear, the second motorized gear, and the third motorized gear based on a set of instructions.

2. A plant growing system, comprising a grow module, wherein the grow module comprises:
a. a housing having a sidewall defining a main cavity, wherein the main cavity has a root zone and a reservoir area;
b. a segmented lid, comprising a first lid piece and a second lid piece, wherein the first lid piece defines a slot into which the second lid piece is inserted to fully assemble the segmented lid, wherein the frilly assembled segmented lid defines a grow hole;
c. a trellis attachable to the sidewall, the trellis extending above the segmented lid when attached to the sidewall; and
d. a reservoir pan occupying the reservoir area and removably attached to the sidewall, the reservoir pan comprising a bottom plate, a raised wall connected to the bottom plate, and an inlet.

3. The plant growing system of claim 2, wherein at least a portion of the sidewall is a dual panel sidewall comprising an inner wall and an outer wall surrounding the inner wall, and wherein the trellis is telescopic having a collapsed configuration and an extended configuration, wherein in the collapsed configuration the trellis is hidden in between the inner wall and the outer wall.

4. The plant growing system of claim 2, further comprising a float valve attached to the reservoir pan through the inlet to control a flow of the water into the reservoir pan, wherein control of the flow of the water is dependent on a water level.

5. The plant growing system of claim 4, wherein the float valve comprises:
a. a float;
b. a valve arm attached to the float;
c. a valve housing attached to the valve arm and configured to fit through the inlet, wherein the valve arm is attached to the valve housing at a hinge, wherein the valve housing comprises a tube lock for locking a piece of tubing inside the valve housing.

6. The plant growing system of claim 2, wherein at least a portion of the sidewall is transparent.

7. The plant growing system of claim 2, further comprising a chute formed in the sidewall for depositing nutrients into the housing from outside of the housing.

8. The plant growing system of claim 2, further comprising a divider that separates the main cavity of the housing into the root zone and the reservoir area, the divider comprising a wicking basket, a plurality of small holes, a main opening leading into the wicking basket.

9. The plant growing system of claim 2, further comprising:
a. an auxiliary wall spaced apart from but connected to the raised wall defining a gap therebetween;
b. an aerator positioned in the reservoir pan; and
c. an air pump housed within the gap between the raised wall and the auxiliary wall, the air pump operatively connected to the aerator.

10. The plant growing system of claim 2, further comprising a sprinkler housed in the root zone.

11. The plant growing system of claim 2, further comprising an atomizer system housed in the reservoir area.

12. The plant growing system of claim 11, wherein the atomizer system comprises:
a. an atomizer to atomize water into a mist;
b. a flow generator to provide water to the atomizer; and
c. a motor to rotate the atomizer to atomize the water.

13. The plant growing system of claim 12, wherein the atomizer comprises
a. a disk that is rotatable when driven by the motor; and
b. a plurality of blades adjacent to the disk and is rotatable with the disk to create airflow.

14. The plant growing system of claim 13, further comprising a diffuser screen positioned around the disk so that the water passes through the diffuser screen.

15. The plant growing system of claim 2, further comprising a plurality of sensors to provide an optimal environment for the plant.

16. The plant growing system of claim 15, further comprising:
a. a water sensor to detect a water level:
b. a temperature sensor to measure a temperature; and
c. a moisture sensor to detect a humidity level.

17. The plant growing system of claim 11, further comprising a netted pot connected to the grow module and hung within the root zone to securely hold a plant seed such that when the seed sprouts roots, the roots spread through and outward from the netted pot and throughout the root zone.

18. The plant growing system of claim 2, further comprising a lift system comprising:
a. a tower; and
b. a plurality of lift plates operatively connected to the tower to revolve around the tower, wherein the plurality of lift plates automatically lift a plurality of grow modules to a respective predetermined optimum distance from a light source, independently of each other.

19. The plant growing system of claim 18, wherein the plurality of lift plates automatically maintain a plurality of grow modules at the predetermined optimum distance, independent from each other.

20. The plant growing system of claim 18, wherein the lift plates automatically rotate the plurality of grow modules independent of each other.

21. The plant growing system of claim 18, further comprising a recording system for monitoring and recording activity of the lift system and the grow modules to correlate growing conditions with growth of a plant.

22. The plant growing system of claim 2, further comprising at least one controller to monitor and adjust the lift system and the grow module to maintain optimum conditions.

23. A plant grow module kit, comprising:
a. a divider to separate a pot into a root zone and a reservoir area;
b. a plurality of supports to elevate the divider for the reservoir area;
c. a measuring device to determine a location for creating an inlet on the pot, wherein the measuring device comprises a pre-cut hole for demarcating the inlet location on the pot, the measuring device and the plurality of supports dimensioned to position the inlet, below the divider;
d. a float valve insertable into the inlet;
e. an aerator positionable under the divider; and
f. tubing attachable to the float valve and a water source to provide a flow of water to the float valve.

24. The kit of claim 23, wherein the float valve comprises a tube lock to quickly and easily lock the tubing into the float valve.

25. The kit of claim 23, further comprising a wedge washer.
